(19) United States
(12) Patent Application Publication
(10) Pub. No.: US 2026/0254611 A1
(43) Pub. Date: Aug. 27, 2026

(54) ELECTRONIC APPARATUS AND CONTROLLING METHOD THEREOF

(71) Applicant: CRYPTO LAB INC., Seoul (KR)

(72) Inventors: Jaehyung Kim, Stanford, CA (US); Elias Suvanto, Seoul (KR); Hyeongmin Choe, Seoul (KR); Damien Stehle, Seoul (KR)

(21) Appl. No.: 19/336,838

(22) Filed: Sep. 23, 2025

(30) Foreign Application Priority Data
Sep. 23, 2024 (KR) 10-2024-0128081
Feb. 14, 2025 (KR) 10-2025-0019661
Aug. 4, 2025 (KR) 10-2025-0106908
Sep. 19, 2025 (KR) 10-2025-0135706

(51) Int. Cl. H04L 9/06; H04L 9/00

(52) U.S. Cl. CPC H04L 9/0618; H04L 9/008

(57) ABSTRACT

An electronic apparatus includes at least one processor including processing circuitry, and memory, wherein the at least one processor is configured to obtain a scale factor and an input ciphertext of a first modulus, obtain a modified scale factor by extending the scale factor to a second modulus, obtain a modified input ciphertext by extending the input ciphertext to the second modulus, obtain a first sub ciphertext by multiplying the modified scale factor by the modified input ciphertext, obtain a second sub ciphertext of a third modulus based on the first sub ciphertext, obtain a third sub ciphertext of a fourth modulus based on the first sub ciphertext and the second sub ciphertext, and obtain a converted ciphertext based on the second sub ciphertext and the third sub ciphertext.

### TECHNICAL FIELD

The disclosure relates to an electronic apparatus and a controlling method thereof, and more particularly, to an electronic apparatus that performs a bootstrapping operation for a ciphertext in a homomorphic encryption environment, and a controlling method thereof.

### Background Art

As communication technologies developed, and distribution of electronic apparatuses has become active, continuous efforts for maintaining communication security between electronic apparatuses are being made. Accordingly, in most communication environments, encryption/decryption technologies are being used.

When a message encrypted by an encryption technology is transmitted to a counterpart, the counterpart should perform decryption for using the message. In this case, waste of resources and time is generated for the counterpart in a process of decrypting the encrypted data. Also, in case hacking of a third party is performed while the counterpart temporarily decrypted the message for an operation, there is a problem that the message can be easily leaked to the third party.

For resolving such problems, a homomorphic encryption method is being studied. According to homomorphic encryption, even if an operation is performed in a ciphertext itself without decrypting the encrypted information, the same result as a value obtained by performing an operation for a plaintext and then encrypting the operation result can be obtained. Accordingly, various types of operations can be performed in a state of not decrypting a ciphertext.

Recently, there has been an effort to use a homomorphic ciphertext in a process of large language model (LLM) inference, and in the aforementioned inference process, high-dimensional matrix multiplications were required.

Accordingly, a method that enables effective performing of a high-dimensional matrix multiplication by using a homomorphic ciphertext was required.

As a high-dimensional matrix operation, a ciphertext-ciphertext matrix multiplication (CCMM) may be performed. As a ciphertext-ciphertext matrix multiplication (CCMM) is a multiplication operation between ciphertexts, a lot of resources may be needed. Also, as there is a lot of processing amount of data, the processing time may take long.

In particular, a modulus used for a calculation process may decrease in an operation process. If the modulus becomes smaller, a noise included in a ciphertext may become similar to the size of the modulus. If the noise included in the ciphertext becomes similar to the size of the modulus, there are problems that it is difficult to distinguish the original message and the noise, and decryption may fail or an operation is not possible anymore.

Here, as more moduli are obtained, additional operational convenience can be increased.

### DISCLOSURE OF INVENTION

### Solution to Problem

According to an embodiment, an electronic apparatus includes at least one processor including processing circuitry, and memory, wherein the at least one processor is configured to obtain a scale factor and an input ciphertext of a first modulus, obtain a modified scale factor by extending the scale factor to a second modulus, obtain a modified input ciphertext by extending the input ciphertext to the second modulus, obtain a first sub ciphertext by multiplying the modified scale factor by the modified input ciphertext, obtain a second sub ciphertext of a third modulus based on the first sub ciphertext, obtain a third sub ciphertext of a fourth modulus based on the first sub ciphertext and the second sub ciphertext, and obtain a converted ciphertext based on the second sub ciphertext and the third sub ciphertext.

The converted ciphertext may be a ciphertext wherein noises decreased in the input ciphertext.

The at least one processor may decompose each coefficient of an integer polynomial included in the input ciphertext into a unit bit in a form of a binary number, and obtain the converted ciphertext wherein the noises in the unit bit decreased.

The at least one processor may obtain the second sub ciphertext by performing a homomorphic multiplication operation (mult) of the first sub ciphertext and the first sub ciphertext.

The at least one processor may obtain a first value by performing a polynomial multiplication (tensor) for the first sub ciphertext and the first sub ciphertext, obtain a second value by performing a relinearization operation for the first value, and obtain the second sub ciphertext by performing a rescale operation in a rescale unit for the second value.

The at least one processor may obtain the third sub ciphertext by performing a homomorphic multiplication operation (mult) of the first sub ciphertext and the second sub ciphertext.

The at least one processor may obtain a first modified ciphertext by modifying the second modulus of the first sub ciphertext to the third modulus, and obtain the third sub ciphertext by performing a homomorphic multiplication operation (mult) of the first modified ciphertext and the second sub ciphertext.

The at least one processor may obtain a fourth value by performing a polynomial multiplication (tensor) for the first modified ciphertext and the second sub ciphertext, obtain a fifth value by performing a relinearization operation for the fourth value, and obtain the third sub ciphertext by performing a rescale operation in the rescale unit for the fifth value.

The at least one processor may obtain the converted ciphertext by applying the second sub ciphertext and the third sub ciphertext to a predetermined purified polynomial.

The at least one processor may obtain a second modified ciphertext by modifying the third modulus of the second sub ciphertext to the fourth modulus, and obtain the converted ciphertext by applying the second modified ciphertext and the third sub ciphertext to the predetermined purified polynomial.

According to an embodiment, a method of controlling an electronic apparatus includes the steps of obtaining a scale factor and an input ciphertext of a first modulus, obtaining a modified scale factor by extending the scale factor to a second modulus, obtaining a modified input ciphertext by extending the input ciphertext to the second modulus, obtaining a first sub ciphertext by multiplying the modified scale factor by the modified input ciphertext, obtaining a second sub ciphertext of a third modulus based on the first sub ciphertext, obtaining a third sub ciphertext of a fourth modulus based on the first sub ciphertext and the second sub ciphertext, and obtaining a converted ciphertext based on the second sub ciphertext and the third sub ciphertext.

The converted ciphertext may be a ciphertext wherein noises decreased in the input ciphertext.

The controlling method may include the step of decomposing each coefficient of an integer polynomial included in the input ciphertext into a unit bit in a form of a binary number, and in the step of obtaining the converted ciphertext, the converted ciphertext wherein the noises in the unit bit decreased may be obtained.

In the step of obtaining the second sub ciphertext, the second sub ciphertext may be obtained by performing a homomorphic multiplication operation (mult) of the first sub ciphertext and the first sub ciphertext.

In the step of obtaining the second sub ciphertext, a first value may be obtained by performing a polynomial multiplication (tensor) for the first sub ciphertext and the first sub ciphertext, a second value may be obtained by performing a relinearization operation for the first value, and the second sub ciphertext may be obtained by performing a rescale operation in a rescale unit for the second value.

In the step of obtaining the third sub ciphertext, the third sub ciphertext may be obtained by performing a homomorphic multiplication operation (mult) of the first sub ciphertext and the second sub ciphertext.

In the step of obtaining the third sub ciphertext, a first modified ciphertext may be obtained by modifying the second modulus of the first sub ciphertext to the third modulus, and the third sub ciphertext may be obtained by performing a homomorphic multiplication operation (mult) of the first modified ciphertext and the second sub ciphertext.

In the step of obtaining the third sub ciphertext, a fourth value may be obtained by performing a polynomial multiplication (tensor) for the first modified ciphertext and the second sub ciphertext, a fifth value may be obtained by performing a relinearization operation for the fourth value, and the third sub ciphertext may be obtained by performing a rescale operation in the rescale unit for the fifth value.

In the step of obtaining the converted ciphertext, the converted ciphertext may be obtained by applying the second sub ciphertext and the third sub ciphertext to a predetermined purified polynomial.

In the step of obtaining the converted ciphertext, a second modified ciphertext may be obtained by modifying the third modulus of the second sub ciphertext to the fourth modulus, and the converted ciphertext may be obtained by applying the second modified ciphertext and the third sub ciphertext to the predetermined purified polynomial.

### BRIEF DESCRIPTION OF DRAWINGS

FIG. 1 is a diagram for illustrating a configuration of a network system according to an embodiment;

FIG. 2 is a diagram for illustrating a configuration of a network system according to an embodiment;

FIG. 3 is a block diagram illustrating an electronic apparatus according to an embodiment;

FIG. 4 is a diagram for illustrating an operation of performing bootstrapping according to an embodiment;

FIG. 5 is a diagram for illustrating an operation of increasing a modulus according to an embodiment;

FIG. 6 is a diagram for illustrating an operation module and a bootstrapping module according to an embodiment;

FIG. 7 is a diagram for illustrating an operation of obtaining a ciphertext wherein a modulus was increased according to an embodiment;

FIG. 8 is a diagram for illustrating a bootstrapping module according to an embodiment;

FIG. 9 is a diagram for illustrating a change of a modulus in a bootstrapping operation according to an embodiment;

FIG. 10 is a diagram for illustrating an operation of controlling precision in a bootstrapping operation according to an embodiment;

FIG. 11 is a diagram for illustrating an operation of converting an integer according to an embodiment;

FIG. 12 is a diagram for illustrating a bit cleaning operation according to an embodiment;

FIG. 13 is a diagram for illustrating a bit cleaning operation according to an embodiment;

FIG. 14 is a block diagram illustrating an electronic apparatus according to an embodiment;

FIG. 15 is a diagram for illustrating a bit cleaning operation according to an embodiment;

FIG. 16 is a diagram for illustrating a Mult function;

FIG. 17 is a diagram for illustrating a bit cleaning operation according to an embodiment;

FIG. 18 is a diagram for illustrating a bit cleaning operation according to an embodiment;

FIG. 19 is a diagram for illustrating a bit cleaning operation according to an embodiment; and

FIG. 20 is a diagram for illustrating a bootstrapping operation according to an embodiment.

FIG. 21 gives an overview of an implementation design for bootstrapping with 81 bits of precision, in terms of modulus consumption of the different components.

FIG. 22 Profiled run-time of Parameter Set Direct3Cln81.

### MODE FOR INVENTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art, previous court decisions, or emergence of new technologies, etc. Also, in particular cases, there may be terms that were arbitrarily designated by the applicant, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic apparatus or an apparatus using an electronic apparatus (e.g.: an artificial intelligence electronic apparatus).

Also, in the disclosure, “a value” is defined as a concept including not only a scalar value but also a vector.

In addition, the mathematical operations and calculation in each step of the disclosure that will be described below can be implemented as computer operations by a coding method known for performing such operations or calculation and/or coding appropriately designed for the disclosure.

Also, the specific mathematical formulae that will be described below are suggested as examples among several possible alternatives, and the scope of the disclosure is not intended to be interpreted to be limited to the mathematical formulae mentioned in the disclosure.

For the convenience of explanation, notations will be defined as follows.
a ←D: An element (a) is selected according to a distribution (D).
s1, s2 ∈R: Each of S1 and S2 is an element belonging to a set R.
mod(q): A modular operation is performed with an element q.
└·┐: The inside value is rounded off.

Hereinafter, various embodiments of the disclosure will be described in detail with reference to the accompanying drawings.

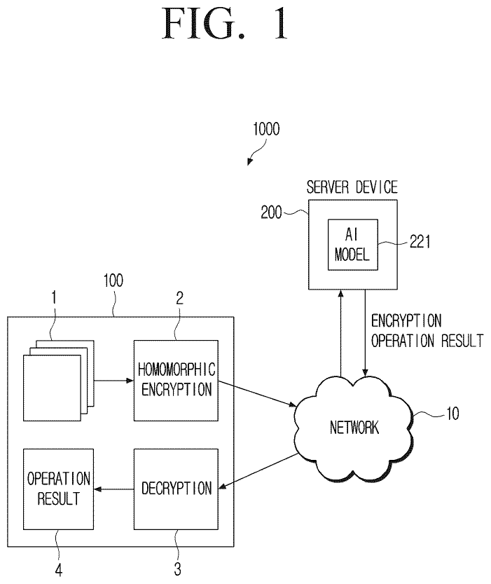

FIG. 1 is a diagram for illustrating a configuration of a network system 1000 according to an embodiment.

Referring to FIG. 1, an electronic apparatus 100 and a server device 200 may perform communication with each other through a network 10. The network 10 may be implemented as various forms of wired and wireless communication networks, broadcasting communication networks, optical communication networks, cloud networks, etc., and each device may be connected by methods such as Wi-Fi, Bluetooth, Near Field Communication (NFC), etc. without a separate medium.

In FIG. 1, one electronic apparatus 100 was illustrated, but the electronic apparatus 100 may be implemented as a plurality of various types. As an example, the electronic apparatus 100 may be apparatuses in various forms such as a smartphone, a tablet, a PC, a laptop PC, a home server, a kiosk, a game player, a camera, etc. Other than the above, the electronic apparatus 100 may also be implemented in a form of a home appliance to which an IoT function is applied.

As an example, in case a camera is included in the electronic apparatus 100, the electronic apparatus 100 may photograph at least one piece of original data 1 by itself and obtain the data. In case a camera is not included, the electronic apparatus 100 may be provided with the original data 1 from an external device (e.g., a camera, a memory stick, etc.) through various types of wired or wireless interfaces. In the various embodiments of the disclosure, the original data 1 may be a photo image, but is not necessarily limited thereto, and it may also be a graphic image. Alternatively, the original data 1 may also be a video content including a plurality of image frames.

The electronic apparatus 100 may obtain a homomorphic ciphertext by performing homomorphic encryption 2 for the at least one piece of original data, and then transmit the homomorphic ciphertext to the server device 200 through the network 10.

In this case, in the process wherein the original data 1 is transmitted, there may be a possibility that the data is hacked and leaked to the outside, or is leaked by the manager of the server device 200. However, if the original data is transmitted in a form of a homomorphic ciphertext, the original data cannot be identified even if it is leaked to the outside. Accordingly, security regarding personal information or physical characteristics of the user can be intensified.

There may be various homomorphic encryption algorithms for generating homomorphic ciphertexts, but in the various embodiments of the disclosure, explanation will be described based on a case wherein homomorphic encryption is performed by using a CKKS Scheme or a modified algorithm based on it.

For transmitting the original data in a form of a homomorphic ciphertext, the electronic apparatus 100 may perform encoding. In homomorphic encryption, encoding may be a task of converting data in an encryptable format. As homomorphic encryption is based on a mathematical structure (e.g., a polynomial operation), in the case of the original data 1, it may be converted into a form that can be processed by a homomorphic encryption algorithm, and then homomorphic encryption may be performed.

In homomorphic encryption, a slot encoding method and a coefficient encoding method may be used in general.

Slot encoding is a method of allotting data to be encrypted into a plurality of slots, and then encoding them in an entire slot unit. A slot means a data unit that can be stored in parallel in one homomorphic ciphertext. In case a ciphertext is expressed in a form of a polynomial, the coefficients or the roots of the polynomial may perform roles of each slot. If one ciphertext consists of n slots in total, n values may be encoded or operated simultaneously. In other words, if slot encoding is performed, a parallel computation for a homomorphic ciphertext may be performed. The slot encoding method may vary according to a homomorphic encryption algorithm. The aforementioned CKKS Scheme may perform slot encoding by using Fast Fourier Transform (FFT).

Coefficient encoding is a method of converting data to be encrypted into a form of a polynomial, and converting the coefficients of the polynomial into encrypted values. The aforementioned CKKS Scheme may perform coefficient encoding by using Discrete Fourier Transform (DFT).

According to an embodiment of the disclosure, the electronic apparatus 100 may perform CinS encoding. CinS encoding means a method of performing slot encoding, and then encoding by performing DFT for a plurality of slot sections but not the entire slots. Detailed explanation in this regard will be described in the parts described below.

Data encoded by the CinS encoding method is referred to as CinS encoding data in the disclosure. The electronic apparatus 100 transmits a homomorphic ciphertext which is a result of performing homomorphic encryption (2) for CinS encoding data to the server device 200.

The server device 200 is a device for performing an operation for a homomorphic ciphertext provided from the electronic apparatus 100 (i.e., at least one piece of original data that was homomorphically encrypted) in a homomorphically encrypted state, and providing a result of the homomorphic operation. The server device 200 may be implemented in various forms such as a web server, a cloud server, etc.

In the server device 200, an AI model 221 for performing an operation in an encrypted state may be stored. In the case of intending to be provided with the original data and performing an operation based on the original data as described above, the AI model 221 may be a convolutional neural network (CNN), but is not necessarily limited thereto.

Specifically, the AI model 221 may perform various operations for a homomorphic ciphertext encrypted by a homomorphic encryption (e.g., the CKKS Scheme) technology, and output the operation result in a form of a homomorphic ciphertext. Hereinafter, an operation result output in a form of a homomorphic ciphertext will be referred to as an encryption operation result.

In case the AI model 221 consists of a CNN, the AI model 221 of the server device 200 performs a convolution operation for each depth or a convolution operation for a homomorphic ciphertext transmitted from the electronic apparatus 100 by using a model parameter. Such an operation method will be described in detail in the parts described below.

The server device 200 transmits an encryption operation result to the electronic apparatus 100 through the network 10. The electronic apparatus 100 may decrypt (3) the received encryption operation result, and provide the operation result (4) to the user. The method of providing a result may vary according to the type and the configuration of the electronic apparatus 100.

As an example, in case the electronic apparatus 100 includes a built-in display, or is connected to an external display (e.g., a monitor), the electronic apparatus 100 may display the decrypted operation result (4).

As an example, in case the electronic apparatus 100 includes a speaker, the electronic apparatus 100 may output a voice message corresponding to the operation result through the speaker.

As an example, in case the electronic apparatus 100 performs communication with another terminal device (e.g., a smartphone, etc.), the electronic apparatus 100 may transmit the decrypted operation result to the terminal device.

As an example, in case the AI model 221 is a model trained to diagnose whether the user has a disease, the operation result may include information on whether the user has a disease, the type of the disease, the proceeding situation, etc. diagnosed based on the original data 1 of the user.

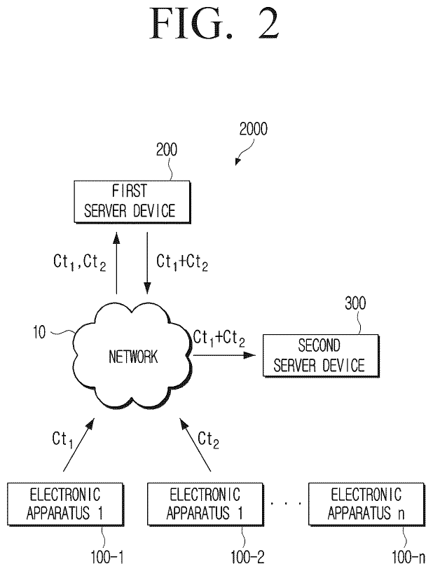

FIG. 2 is a diagram for illustrating a configuration of a network system 2000 according to an embodiment.

Referring to FIG. 2, the network system may include a plurality of electronic apparatuses 100-1-100-n, a first server device 200, and a second server device 300, and each component may be connected with one another through the network 10.

The network 10 may be implemented as various forms of wired and wireless communication networks, broadcasting communication networks, optical communication networks, cloud networks, etc., and each device may be connected by methods such as Wi-Fi, Bluetooth, Near Field Communication (NFC), etc. without a separate medium.

In FIG. 2, it was illustrated that there are a plurality of electronic apparatuses 100-1-100-n, but a plurality of electronic apparatuses do not necessarily have to be used, and one apparatus may be used. As an example, the electronic apparatuses 100-1-100-n may be implemented as apparatuses in various forms such as a smartphone, a tablet, a game player, a PC, a laptop PC, a home server, a kiosk, etc., and may also be implemented in a form of a home appliance to which an IoT function is applied other than them.

The user may input various types of information through the electronic apparatuses 100-1-100-n that the user uses. The input information may be stored in the electronic apparatuses 100-1-100-n themselves, but may also be transmitted to an external device and stored for reasons of the storage capacity and security, etc. In FIG. 2, the first server device 200 may perform a role of storing such information, and the second server device 300 may perform a role of using some or all of the information stored in the first server device 200.

Each electronic apparatus 100-1-100-n may homomorphically encrypt the input information, and transmit a homomorphic ciphertext to the first server device 200.

Each electronic apparatus 100-1-100-n may include an encryption noise, i.e., an error calculated in a process of performing homomorphic encryption in the ciphertext. Specifically, homomorphic ciphertexts generated in each electronic apparatus 100-1-100-n may be generated in a form wherein a result value including a message and an error value is restored when the ciphertext is decrypted by using a secret key later.

As an example, homomorphic ciphertexts generated in the electronic apparatuses 100-1-100-n may be generated in a form that satisfies the property as follows when the ciphertext is decrypted by using a secret key.

$$Dec ( ct , sk ) = < ct , sk > = M + e ( mod q ) \qquad [ Formula 1 ]$$

Here, <, > means a usual inner product, ct means a ciphertext, sk means a secret key, M means a plaintext message, e means an encryption error value, and mod q means a modulus of a ciphertext. q should be selected to be bigger than a result value M of multiplying a message by a scaling factor Δ. If an absolute value of the error value e is sufficiently smaller than M, a decryption value of the ciphertext M+e is a value that can replace the original message by the same precision in a significant figures operation. In the decrypted data, the error may be arranged on the side of the least significant bit (LSB), and M may be arranged on the side of the second least significant bit.

In case a size of a message is too small or too big, the size may be adjusted by using a scaling factor. If a scaling factor is used, not only a message in an integer form but also a message in a real number form can be encrypted, and thus usability can be increased greatly. Also, as a size of a message is adjusted by using a scaling factor, a size of an area wherein messages exist, i.e., an effective area in a ciphertext after an operation was performed may also be adjusted.

According to an embodiment, a modulus q of a ciphertext may be used by being set as various forms. As an example, a modulus of a ciphertext may be set as a form of q=Δ^{L} which is an exponent of a scaling factor Δ. If Δ is 2, it may be set as a value like q=2¹⁰.

Also, while explanation is described by assuming that a fixed-point is used in a homomorphic ciphertext according to the disclosure, but the disclosure can also be applied to a case wherein a floating point is used.

The first server device 200 may not decrypt the received homomorphic ciphertext, but store it in a state of a ciphertext.

The second server device 300 may request a specific processing result for the homomorphic ciphertext to the first server device 200. The first server device 200 may perform a specific operation according to the request of the second server device 300, and transmit the result to the second server device 300.

As an example, in case ciphertexts ct1 and ct2 transmitted by two electronic apparatuses 100-1, 100-2 are stored in the first server device 200, the second server device 300 may request a value of summing up the information provided from the two electronic apparatuses 100-1, 100-2 to the first server device 200. The first server device 200 may perform an operation of summing up the two ciphertexts according to the request, and then transmit the result value (ct1+ct2) to the second server device 300.

Because of a property of a homomorphic ciphertext, the first server device 200 may perform an operation in a state wherein decryption was not performed, and the result value also becomes a form of a ciphertext. In the disclosure, a result value obtained by an operation is referred to as an operation result ciphertext.

The first server device 200 may transmit the operation result ciphertext to the second server device 300. The second server device 300 may decrypt the received operation result ciphertext, and obtain an operation result value of the data included in each homomorphic ciphertext.

Meanwhile, the electronic apparatus 100 may obtain a homomorphic ciphertext by using a residual number system (RNS) modulus including a plurality of moduli having a size corresponding to a word size of the electronic apparatus 100, and perform an operation for the homomorphic ciphertext by using a rational rescale. According to one or more embodiments, the plurality of moduli may include sprout moduli consisting of a multiplication of decimals having a size smaller than or equal to the word size, and the electronic apparatus 100 may perform various operations (e.g., a key switching operation, etc.) for the homomorphic ciphertext by using the sprout moduli. According to one or more embodiments, the electronic apparatus 100 may perform a key switching operation for the homomorphic ciphertext by generating a middle modulus by upscaling the RNS modulus, performing a key switching operation for the middle modulus, and performing rescaling for the middle modulus for which the key switching operation was performed.

By this, the electronic apparatus 100 can perform an effective multiplication operation while minimizing the number of the RNS moduli, and thus a swifter operation for a homomorphic ciphertext becomes possible.

Meanwhile, in FIG. 2, a case wherein encryption is performed in the first electronic apparatus and the second electronic apparatus, and the second server device performs decryption was illustrated, but the disclosure is not necessarily limited thereto.

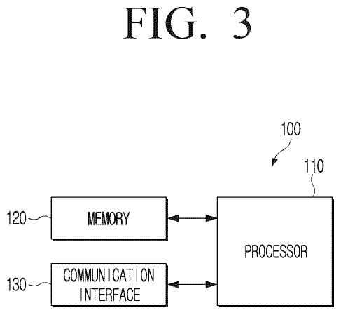

FIG. 3 is a block diagram for illustrating a configuration of an electronic apparatus according to an embodiment.

Referring to FIG. 3, the electronic apparatus 100 may include at least one processor 110 including processing circuitry, and memory 120 storing instructions. The at least one processor 110 may perform the following operations by executing the instructions.

The electronic apparatus 100 may include at least one processor 110 including processing circuitry, and memory 120.

The at least one processor 110 may receive an instruction for an operation from an external device or the user.

As an example, the electronic apparatus 100 may include a communication interface 130. The at least one processor 110 may receive an instruction for an operation or a ciphertext which becomes a subject for an instruction for an operation through the communication interface 130. As an example, there may be a plurality of ciphertexts.

The at least one processor 110 may perform an operation action for a first ciphertext (Δ₁m) based on an instruction for an operation for the first ciphertext (Δ₁m). Δ₁m described in the parentheses of the ciphertext may indicate a decryption result corresponding to the ciphertext. The value described in the parentheses of the ciphertext does not indicate the ciphertext itself, and is merely a value for intuitively indicating the ciphertext. Regarding ciphertexts below, a format of a ciphertext (x) may also be described as a value for indicating the ciphertext in the same manner. A ciphertext itself may be described in a form of (a, b). As an example, a, b may mean a polynomial.

As an example, the at least one processor 110 may store the first ciphertext (Δ₁m) in the memory 120. The at least one processor 110 may obtain the first ciphertext (Δ₁m) from the memory 120.

The at least one processor 110 may receive the instruction for an operation for the first ciphertext (Δ₁m). When the instruction for an operation is received, the at least one processor 110 may identify the first ciphertext (Δ₁m) which becomes a subject for the operation.

The at least one processor 110 may execute the instruction for an operation for the first ciphertext (Δ₁m). In the first ciphertext (Δ₁m), the first scaling factor Δ₁ and m may indicate data indicating at least one of a real number or a complex number. m may be an encrypted vector value. Also, m may indicate data (or a message) that is sought to be expressed by the ciphertext.

The scaling factor Δ may indicate a constant number that is multiplied for approximating data (or a message) of a real number or a complex number to an integer-valued polynomial and encrypting it. Also, the scaling factor Δ may be a constant number value that is multiplied for approximating a message in a real number form to an integer form. The scaling factor Δ may be used for adjusting the precision of expression within the ciphertext, and restoring the original real number value at the time of decryption.

The at least one processor 110 may obtain a second ciphertext (Δ₁m+e₁) including a noise e₁ based on an operation action (or an instruction for an operation). The noise e₁ that did not exist in the first ciphertext (Δ₁m) may be included in the second ciphertext (Δ₁m+e₁). In the operation process, noises may keep being generated.

Meanwhile, as the operation action is performed, the modulus of the ciphertext may decrease. The modulus may be a reference value that is used for limiting a size of a number in the operation action. The modulus may indicate a number that makes a calculation result expressed in the remaining form based on a specific value.

The at least one processor 110 may determine whether a predetermined event is identified based on the modulus q1 of the second ciphertext (Δ₁m+e₁).

If the predetermined event is not identified based on the modulus q1 of the second ciphertext (Δ₁m+e₁), the at least one processor 110 may keep performing the operation action.

If the predetermined event is identified based on the modulus q1 of the second ciphertext (Δ₁m+e₁), the at least one processor 110 may perform bootstrapping.

The bootstrapping may mean an operation of increasing the modulus of the ciphertext. Also, the bootstrapping may indicate an operation of increasing the modulus while maintaining the original data Δ₁m in the ciphertext.

If the predetermined event is identified based on the modulus q1 of the second ciphertext (Δ₁m+e₁), the at least one processor 110 may perform bootstrapping based on a first scaling factor Δ₁, a second scaling factor Δ₂, and a third scaling factor Δ₃ different from one another, and may thereby obtain an output ciphertext (Δ₁m+e₆) having a bigger modulus q2 than the modulus q1 of the second ciphertext (Δ₁m+e₁).

Each of the first scaling factor Δ₁, the second scaling factor Δ₂, and the third scaling factor Δ₃ may be different from one another.

The second scaling factor Δ₂ may be bigger than the third scaling factor Δ₃. If the scaling factor Δ increases, precision of a calculation may increase. Accordingly, in the case of using the second scaling factor Δ₂, a result of better precision may be obtained than in a case of using the third scaling factor Δ₃. However, in the case of using the second scaling factor Δ₂, a processing amount of an operation may be more than in a case of using the third scaling factor Δ₃.

The at least one processor 110 may obtain an output ciphertext (Δ₁m+e₆) by using the second scaling factor Δ₂ and the third scaling factor Δ₃ other than the first scaling factor Δ₁ used in the initial first ciphertext (Δ₁m). The output ciphertext may be described as an eighth ciphertext.

The at least one processor 110 may perform an additional operation action based on the output ciphertext (Δ₁m+e₆).

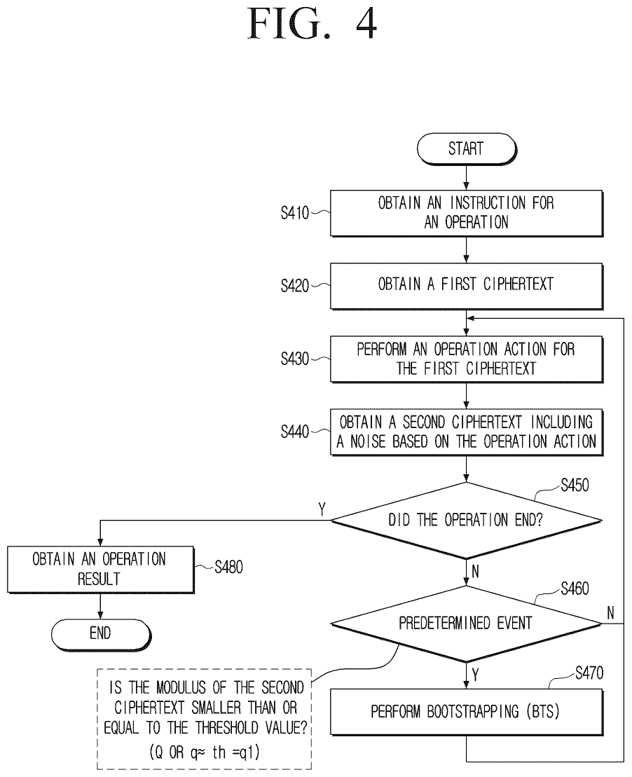

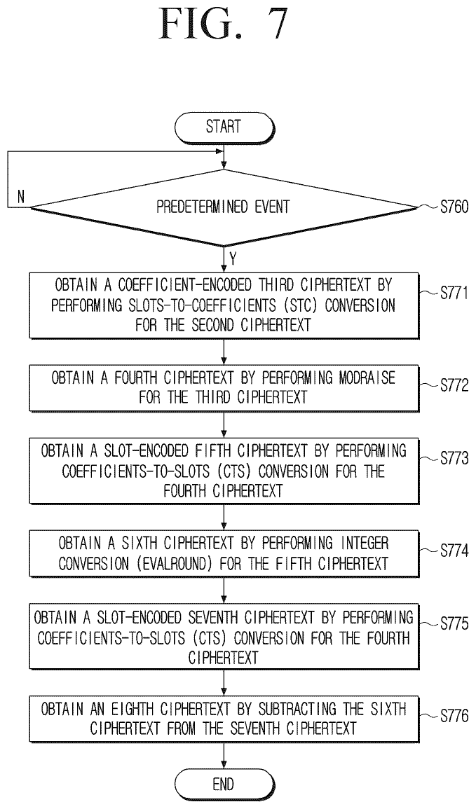

If the modulus q1 of the second ciphertext (Δ₁m+e₁) is smaller than or equal to a threshold value, the at least one processor 110 may identify that the predetermined event occurred. Explanation in this regard will be described in the step S460 in FIG. 4 and the step S760 in FIG. 7.

The at least one processor 110 may obtain a coefficient-encoded third ciphertext (Δ₂m+e₂) by performing Slots-to-Coefficients (StC) conversion for the second ciphertext (Δ₁m+e₁) based on the second scaling factor Δ₂ different from the first scaling factor Δ₁. The at least one processor 110 may obtain the output ciphertext (Δ₁m+e₆) by performing modulus expansion for the third ciphertext (Δ₂m+e₂).

The at least one processor 110 may obtain a fourth ciphertext (q₀I+Δ₂m+e₂) by performing ModRaise of expanding the modulus for the third ciphertext (Δ₂m+e₂). The at least one processor 110 may obtain the output ciphertext (Δ₁m+e₆) based on the fourth ciphertext (q₀I+Δ₂m+e₂).

The at least one processor 110 may obtain a slot-encoded fifth ciphertext (Δ₃I+e₃) by performing first coefficients-to-slots (CtS) conversion for the fourth ciphertext (q₀I+Δ₂m+e₂) based on the third scaling factor Δ₃ smaller than the second scaling factor Δ₂.

The at least one processor 110 may obtain a sixth ciphertext (q₀I+e₄) by filtering a second portion other than a first portion indicating an integer in the fifth ciphertext (Δ₃I+e₃).

The at least one processor 110 may obtain an output ciphertext (Δ₁m+e₆) based on the sixth ciphertext (q₀I+e₄).

The at least one processor 110 may obtain a slot-encoded seventh ciphertext (q₀I+Δ₂m+e₂) by performing second coefficients-to-slots (CtS) conversion for the fourth ciphertext (q₀I+Δ₂m+e₂) based on the second scaling factor Δ₂.

The at least one processor 110 may obtain an output ciphertext (Δ₁m+e₆) based on the sixth ciphertext (q₀I+e₄) and the seventh ciphertext (q₀I+Δ₂m+e₂).

The at least one processor 110 may obtain an eighth ciphertext (Δ₁m+e₆) indicating the output ciphertext (Δ₁m+e₆) by subtracting the sixth ciphertext (q₀I+e₄) from the seventh ciphertext (q₀I+Δ₂m+e₂).

The at least one processor 110 may obtain the eighth ciphertext (Δ₁m+e₆) by using the first scaling factor Δ₁ instead of the second scaling factor Δ₂.

The at least one processor 110 may obtain a remining modulus q₂/q₁ based on a difference value between a modulus q₂ of the eighth ciphertext (Δ₁m+e₆) and a modulus q₁ of the second ciphertext (Δ₁m+e₁). The at least one processor 110 may perform an additional operation action based on the remaining modulus q₂/q₁.

The electronic apparatus 100 may perform an additional operation action as much as the remaining modulus q₂/q₁. The electronic apparatus 100 may determine that it is difficult to perform an operation action anymore at the modulus q₁ of the second ciphertext (Δ₁m+e₁). The electronic apparatus 100 may secure a modulus for an additional operation through a bootstrapping operation.

The electronic apparatus 100 may use a plurality of scaling factors Δ for performing a bootstrapping operation. The electronic apparatus 100 may use the third scaling factor Δ₃ which is relatively small only for some operations among a plurality of detailed operations included in the bootstrapping operation. Accordingly, the electronic apparatus 100 can improve the overall operation speed and operation efficiency.

FIG. 4 is a diagram for illustrating an operation of performing bootstrapping according to an embodiment.

Referring to FIG. 4, the electronic apparatus 100 may obtain an instruction for an operation in the step S410. The electronic apparatus 100 may obtain an instruction for an operation related to homomorphic encryption. The instruction for an operation may indicate an instruction for performing an operation related to homomorphic encryption.

The electronic apparatus 100 may obtain a first ciphertext in the step S420. The electronic apparatus 100 may obtain the first ciphertext which becomes a subject of the instruction for an operation.

The electronic apparatus 100 may perform an operation action for the first ciphertext in the step S430. The electronic apparatus 100 may obtain an operation action corresponding to the instruction for an operation. The electronic apparatus 100 may execute the instruction for an operation for the first ciphertext.

The electronic apparatus 100 may obtain a second ciphertext including a noise based on the operation action in the step S440. If an operation for homomorphic encryption is performed, a noise may be included in the operation result. The electronic apparatus 100 may obtain the second ciphertext including a noise as an operation result for the first ciphertext.

The electronic apparatus 100 may identify ending of the operation in the step S450. The electronic apparatus 100 may identify whether all operation actions corresponding to the instruction for an operation were completed.

If the operation action did not end in the step S450-N, the electronic apparatus 100 may identify whether a predetermined event occurred in the step S460.

As an example, the predetermined event may include an event wherein a modulus of a ciphertext of an operation result is smaller than or equal to a threshold value. For example, the predetermined event may include an event wherein the modulus of the second ciphertext is smaller than or equal to the threshold value. The threshold value may be changed according to the user's setting.

If the predetermined event is not identified in the step S460-N, the electronic apparatus 100 may repeat the steps S430, S440, S450, and S460.

If the predetermined event is identified in the step S460-Y, the electronic apparatus 100 may perform bootstrapping in the step S470. The electronic apparatus 100 may obtain a ciphertext wherein a modulus increased through bootstrapping. The electronic apparatus 100 may perform bootstrapping for securing a modulus.

In case an operation action using homomorphic encryption is performed, a modulus may decrease. In case a modulus decreases, an operation for homomorphic encryption may be impossible. Accordingly, the electronic apparatus 100 may perform bootstrapping for increasing the modulus. Bootstrapping may be an operation for securing a modulus. The electronic apparatus 100 may perform bootstrapping for securing a modulus.

When the bootstrapping operation is completed, the electronic apparatus 100 may repeat the steps S430, S440, S450, and S460.

If the operation action ended in the step S450-Y, the electronic apparatus 100 may obtain an operation result in the step S480. The electronic apparatus 100 may store the operation result in the memory 120.

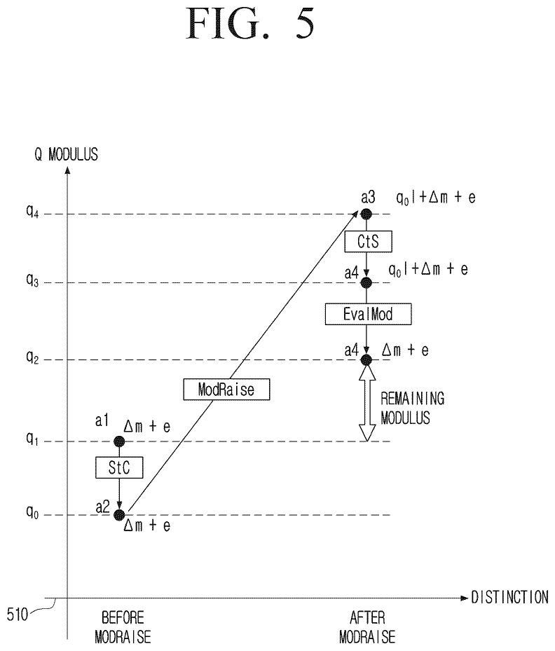

FIG. 5 is a diagram for illustrating an operation of increasing a modulus according to an embodiment.

Referring to the graph 510 in FIG. 5, the electronic apparatus 100 may perform bootstrapping for securing a modulus in homomorphic encryption.

The electronic apparatus 100 may obtain a ciphertext (Δm+e) wherein a modulus is q₁ as a result of an operation action for homomorphic encryption (a1). Δ may mean a scaling factor. m may mean an encrypted content. e may mean a noise.

The electronic apparatus 100 may obtain a coefficient-encoded ciphertext (Δm+e) wherein a modulus is q₀ by performing Slots-to-Coefficients (StC) conversion for the ciphertext (Δm+e) wherein a modulus is q₁ (a2).

The electronic apparatus 100 may increase the modulus by performing ModRaise (a3). The electronic apparatus 100 may obtain a ciphertext (q₀I+Δm+e) wherein a modulus is q₄ as a result of ModRaise.

The electronic apparatus 100 may obtain a slot-encoded ciphertext (q₀I+Δm+e) by performing coefficients-to-slots (CtS) conversion for the ciphertext (q₀I+Δm+e) wherein a modulus is q₄ (a4). The modulus of the slot-encoded ciphertext (q₀I+Δm+e) may be q₃.

The electronic apparatus 100 may perform EvalMod for the slot-encoded ciphertext (q₀I+Δm+e). The electronic apparatus 100 may obtain a ciphertext (Δm+e) wherein the integer was removed based on EvalMod (a5). The modulus of the ciphertext (Δm+e) wherein the integer was removed may be q₂.

The electronic apparatus 100 may ultimately obtain a ciphertext (Δm+e) wherein a modulus is q₂. The electronic apparatus 100 may increase the modulus from q₁ to q₂. The electronic apparatus 100 may perform an operation action for homomorphic encryption based on the ciphertext wherein the modulus increased.

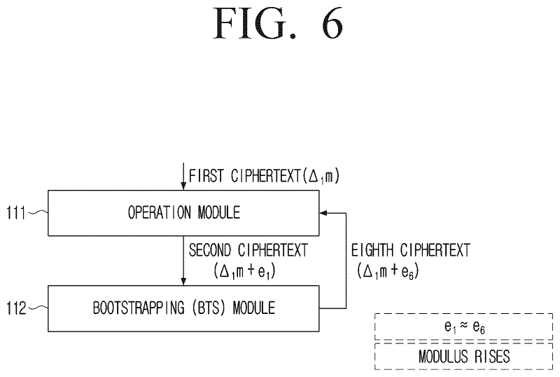

FIG. 6 is a diagram for illustrating an operation module and a bootstrapping module according to an embodiment.

Referring to FIG. 6, the electronic apparatus 100 may include an operation module 111 and a bootstrapping module 112.

The electronic apparatus 100 may be an apparatus that operates homomorphic encryption. The homomorphic encryption may indicate encryption wherein an operation is performed in an encrypted state. Also, the homomorphic encryption may indicate encryption wherein an addition or a multiplication is homomorphically performed regarding approximate values of a real number (or a complex number). The electronic apparatus 100 may perform an operation for the encrypted real number vector.

The operation module 111 may be a module that performs an operation action for homomorphic encryption. The operation module 111 may be a module that is constituted to perform a homomorphic operation (e.g.: an addition, a multiplication, etc.) for encrypted data. Also, the operation module 111 may be a module that is constituted to perform a homomorphic operation such as an addition, a multiplication, etc. between ciphertexts for processing data in an encrypted state without decryption.

The operation module 111 may perform an operation in a vector unit for a ciphertext which is a subject for the operation. If an operation action is performed by the operation module 111, a noise may be generated for the ciphertext which is a subject for the operation. Also, if an operation action is performed by the operation module 111, a modulus of the ciphertext which is a subject for the operation may decrease.

A modulus may indicate an integer coefficient that is used in an encryption operation or a decryption operation. Also, a modulus may be a reference value that is used for limiting a size of a number in an encryption operation. A modulus may indicate a number that makes a calculation result expressed in the remaining form based on a specific value.

A modulus may be a mathematical parameter that is used for suppressing increase of noises and maintaining the precision of a ciphertext in a homomorphic operation by controlling such that a coefficient within the ciphertext does not exceed a specific range.

In a homomorphic encryption operation, a rescale operation is performed for maintaining the precision after a multiplication, and a modulus should be divided into smaller moduli in this process, and thus the modulus may gradually decrease in the operation process. If the modulus becomes too small, a noise included in a ciphertext becomes similar to the size of the modulus, and thus it may become difficult to distinguish the original message.

The electronic apparatus 100 needs to increase a modulus of a ciphertext for performing an operation action for the ciphertext. The electronic apparatus 100 may perform bootstrapping for increase of the modulus.

The electronic apparatus 100 may receive an instruction for an operation. The electronic apparatus 100 may execute an instruction for an operation for the first ciphertext (Δ₁m). The electronic apparatus 100 may input the first ciphertext (Δ₁m) into the operation module 111.

The operation module 111 may perform an operation action for the first ciphertext (Δ₁m). The operation module 111 may obtain a second ciphertext (Δ₁m+e₁) as an operation result for the first ciphertext (Δ₁m).

In case it is determined that bootstrapping is needed, the electronic apparatus 100 may transmit a ciphertext to the bootstrapping module 112. The electronic apparatus 100 may transmit the second ciphertext (Δ₁m+e₁) output from the operation module 111 to the bootstrapping module 112.

The bootstrapping module 112 may be a module that performs a bootstrapping operation for a ciphertext which becomes a subject for an operation of homomorphic encryption.

According to an embodiment, the bootstrapping module 112 may increase a modulus.

The bootstrapping module 112 may obtain an eighth ciphertext (Δ₁m+e₆) wherein a modulus was increased. The modulus of the eighth ciphertext (Δ₁m+e₆) may be bigger than the modulus of the second ciphertext (Δ₁m+e₁). The eighth ciphertext (Δ₁m+e₆) wherein the modulus was increased may be used in an operation action again. The noise e7 included in the eighth ciphertext (Δ₁m+e₆) and the noise e1 included in the second ciphertext (Δ₁m+e₁) may be different. The difference of the noises may be an approximate value compared to the ciphertexts.

The bootstrapping module 112 may transmit the eighth ciphertext (Δ₁m+e₆) to the operation module 111. The operation module 111 may perform an operation action based on the received eighth ciphertext (Δ₁m+e₆).

According to an embodiment, the bootstrapping module 112 may be a module that was constituted to decrease a noise that increased in a process of performing a homomorphic operation, and thereby re-process a ciphertext such that the precision of the ciphertext is restored and an additional operation is possible.

FIG. 7 is a diagram for illustrating an operation of obtaining a ciphertext wherein a modulus was increased according to an embodiment.

The step S760 in FIG. 7 may correspond to the step S460 in FIG. 4. The operations in FIG. 4 may be applied identically to the embodiment in FIG. 7. The electronic apparatus 100 may identify whether a predetermined occurred in the step S760.

As an example, the predetermined event may include an event wherein a modulus of a ciphertext obtained as an operation result is smaller than or equal to a threshold value. For example, the predetermined event may include an event wherein a modulus of the second ciphertext is smaller than or equal to the threshold value. The threshold value may be changed according to the user's setting.

If the predetermined event is identified in the step S760-Y, the electronic apparatus 100 may obtain a coefficient-encoded third ciphertext (Δ₂m+e₂) by performing Slots-to-Coefficients (StC) conversion for the second ciphertext (Δ₁m+e₁) in the step S771. The Slots-to-Coefficients (StC) conversion may indicate an operation of converting a ciphertext encoded in a form of a slot into a form of a polynomial coefficient.

The electronic apparatus 100 may obtain a fourth ciphertext (q₀I+Δ₂m+e₂) by performing ModRaise for the third ciphertext (Δ₂m+e₂) in the step S772. The ModRaise may indicate an operation of converting a ciphertext using a low modulus into a ciphertext using a higher modulus. In case ModRaise is performed, the original message may be maintained in the ciphertext, but an additional integer polynomial term may be added.

The electronic apparatus 100 may obtain a slot-encoded fifth ciphertext (Δ₃I+e₃) by performing coefficients-to-slots (CtS) conversion for the fourth ciphertext (q₀I+Δ₂m+e₂) in the step S773. The coefficients-to-slots (CtS) conversion may indicate an operation of converting a ciphertext encoded in a form of a polynomial coefficient into a slot form in a form of a complex number vector.

The electronic apparatus 100 may obtain a sixth ciphertext (q₀I+e₄) by performing integer conversion (EvalRound) for the fifth ciphertext (Δ₃I+e₃) in the step S774. The integer conversion may indicate conversion wherein filtering (or cleaning) is performed such that only an integer polynomial remains in an integer polynomial including a noise. The electronic apparatus 100 may remove the other decimal parts through integer conversion such that the q0I portion included in the ciphertext remains.

The electronic apparatus 100 may obtain a slot-encoded seventh ciphertext (q₀I+Δ₂m+e₂) by performing coefficients-to-slots (CtS) conversion for the fourth ciphertext (q₀I+Δ₂m+e₂) in the step S775.

The electronic apparatus 100 may obtain an eighth ciphertext (Δ₁m+e₆) by subtracting the sixth ciphertext (q₀I+e₄) from the seventh ciphertext (q₀I+Δ₂m+e₂) in the step S776. The noise e₆ included in the eighth ciphertext (Δ₁m+e₆) and the noise e₂ included in the second ciphertext (Δ₁m+e₁) may be different. However, the modulus of the eighth ciphertext (Δ₁m+e₆) may be bigger than the modulus of the second ciphertext (Δ₁m+e₁). Accordingly, the electronic apparatus 100 may perform an additional operation by using the eighth ciphertext (Δ₁m+e₆) having an expanded modulus.

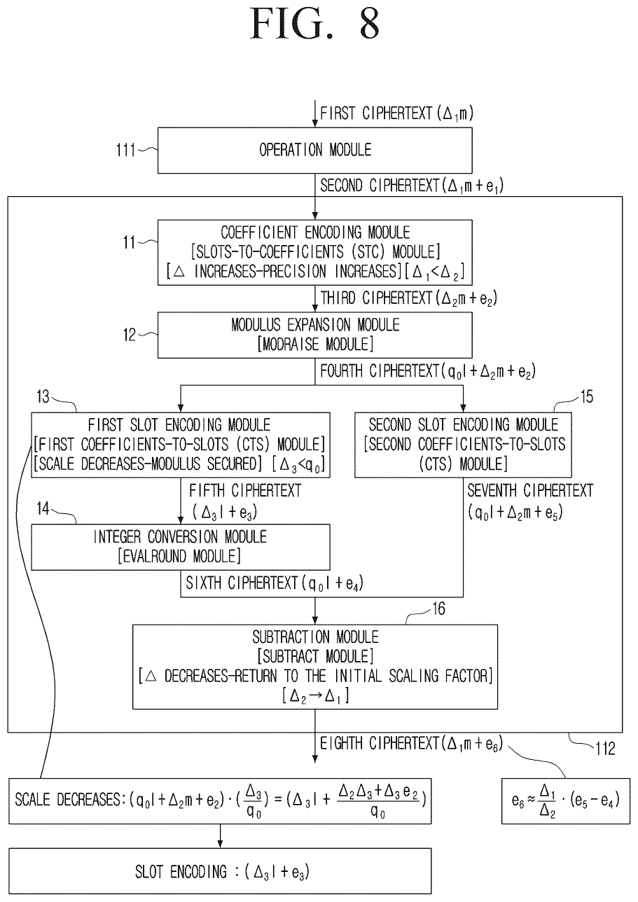

FIG. 8 is a diagram for illustrating a bootstrapping module according to an embodiment.

Referring to FIG. 8, the electronic apparatus 100 may include an operation module 111 and a bootstrapping module 112. The bootstrapping module 112 may include at least one of a coefficient encoding module 11, a modulus expansion module 12, a first slot encoding module 13, an integer conversion module 14, a second slot encoding module 15, or a subtraction module 16.

The electronic apparatus 100 may obtain an instruction for an operation. The electronic apparatus 100 may obtain a first ciphertext (Δ₁m) which is a subject for the instruction for an operation. The electronic apparatus 100 may input the first ciphertext (Δ₁m) into the operation module 111 as input data. The operation module 111 may perform a predetermined operation action for the first ciphertext (Δ₁m). The operation action may include performing a predetermined operation algorithm related to homomorphic encryption. The operation module 111 may obtain a second ciphertext (Δ₁m+e₁) as output data as the operation result. The operation module 111 may transmit the second ciphertext (Δ₁m+e₁) to the bootstrapping module 112.

The bootstrapping module 112 may transmit the second ciphertext (Δ₁m+e₁) transmitted by the operation module 111 to the coefficient encoding module 11.

The coefficient encoding module 11 may be a module that performs Slots-to-Coefficients (StC) conversion. Also, the coefficient encoding module 11 may be a module that converts a ciphertext encoded in a form of a slot into a form of a polynomial coefficient.

The coefficient encoding module 11 may receive the second ciphertext (Δ₁m+e₁). The coefficient encoding module 11 may obtain a third ciphertext (Δ₂m+e₂) as output data by performing StC conversion for the second ciphertext (Δ₁m+e₁). The coefficient encoding module 11 may transmit the third ciphertext (Δ₂m+e₂) to the modulus expansion module 12.

The coefficient encoding module 11 may change the scaling factor Δ while performing StC conversion. The coefficient encoding module 11 may change the first scaling factor Δ₁ to the second scaling factor Δ₁. The second scaling factor Δ₂ may be a bigger value than the first scaling factor Δ₁. If the scaling factor Δ increases, the precision of a calculation may increase.

The noise e1 included in the second ciphertext (Δ₁m+e₁) and the noise e2 included in the third ciphertext (Δ₂m+e₂) may be different.

The modulus expansion module 12 may be a module that expands a modulus consumed in a calculation process. The modulus expansion module 12 may perform an operation of increasing a range (=a modulus) of numbers used in a ciphertext to be bigger. The modulus expansion module 12 may perform an operation of adding a value q₀I which is a result of multiplying a modulus q₀ by a polynomial I. The operation of expanding a modulus may be described as an operation of performing ModRaise.

The modulus expansion module 12 may receive a third ciphertext (Δ₂m+e₂) from the coefficient encoding module 11. The modulus expansion module 12 may obtain a fourth ciphertext (q₀I+Δ₂m+e₂) by adding the value q₀I which is a result of multiplying the modulus q₀ by the polynomial I to the third ciphertext (Δ₂m+e₂). The modulus expansion module 12 may transmit the fourth ciphertext (q₀I+Δ₂m+e₂) to the first slot encoding module 13. The modulus expansion module 12 may transmit the fourth ciphertext (q₀I+Δ₂m+e₂) to the second slot encoding module 15.

The noise e₂ included in the third ciphertext (Δ₂m+e₂) and the noise e₂ included in the fourth ciphertext (q₀I+Δ₂m+e₂) may be identical.

The first slot encoding module 13 may be a module that performs coefficients-to-slots (CtS) conversion. Also, the first slot encoding module 13 may be a module that performs an operation of converting a ciphertext encoded in a form of a polynomial coefficient into a slot form in a form of a complex number vector.

The first slot encoding module 13 may receive the fourth ciphertext (q₀I+Δ₂m+e₂) from the modulus expansion module 12. The first slot encoding module 13 may obtain a fifth ciphertext (Δ₃I+e₃) encoded in a slot form by performing CtS conversion for the fourth ciphertext (q₀I+Δ₂m+e₂). The first slot encoding module 13 may transmit the fifth ciphertext (Δ₃I+e₃) to the integer conversion module 14.

The first slot encoding module 13 may decrease the scaling factor Δ. The first slot encoding module 13 may change the second scaling factor Δ₂ to the third scaling factor Δ₃ while performing CtS conversion. The third scaling factor Δ₃ may be a smaller value than the second scaling factor Δ₂.

The first slot encoding module 13 may perform a scale decreasing operation and a slot encoding operation. The scale decreasing operation may indicate an operation of multiplying the fourth ciphertext (q₀I+Δ₂m+e₂) by Δ₃/q₀. The first slot encoding module 13 by the scale decreasing operation. Here, Δ₃ may be smaller may obtain

$$( {Δ}_{3} I + \frac{{Δ}_{2} {Δ}_{3} \cdot m + {Δ}_{3} {e}_{2}}{{q}_{0}} )$$

by the scale decreasing operation. Here Δ₃ may be smaller than q0. Accordingly, Δ₃/q0 may have a value smaller than 1. The fourth ciphertext may be a form wherein I was multiplied by q0, but the fifth ciphertext may be a form wherein I was multiplied by Δ₃. Accordingly, the scaling factor may decrease from q0 to Δ₃ based on I. The first slot encoding module 13 may secure a modulus through scale decrease.

The first slot encoding module 13 may perform slot encoding for the result value regarding the scale decrease. The first slot encoding module 13 may obtain a fifth ciphertext (Δ₃I+e₃) by performing CtS conversion for

$$( {Δ}_{3} I + \frac{{Δ}_{2} {Δ}_{3} \cdot m + {Δ}_{3} {e}_{2}}{{q}_{0}} ) .$$

The noise e₂ included in the fourth ciphertext (q₀I+Δ₂m+e₂) and the noise e₃ included in the fifth ciphertext (Δ₃I+e₃) may be different.

The integer conversion module 14 may be a module that performs filtering (or cleaning) such that only an integer polynomial remains in an integer polynomial including a noise. The integer conversion module 14 may be described as an EvalRound module. The integer conversion module 14 may be described as a filtering module.

The integer conversion module 14 may receive the fifth ciphertext (Δ₃I+e₃) from the first slot encoding module 13. The integer conversion module 14 may obtain a sixth ciphertext (q₀I+e₄) as output data by performing a filtering (or cleaning) operation for excluding parts that are not an integer in the fifth ciphertext (Δ₃I+e₃). The integer conversion module 14 may transmit the sixth ciphertext (q₀I+e₄) to the subtraction module 16.

In the fifth ciphertext (Δ₃I+e₃), data corresponding to the integer part may be q0I. Also, in the fifth ciphertext (Δ₃I+e₃), data corresponding to parts that are not an integer may be 43m+e₃. The integer conversion module 14 may remove the data corresponding to the parts that are not an integer (Δ₃m+e₃) in the fifth ciphertext (Δ₃I+e₃). A noise may be generated in the removing operation. Accordingly, the sixth ciphertext (q₀I+e₄) may include a noise e₄.

The noise e₃ included in the fifth ciphertext (Δ₃I+e₃) and the noise e₄ included in the sixth ciphertext (q₀I+e₄) may be different.

The second slot encoding module 15 may be a module that performs coefficients-to-slots (CtS) conversion. Also, the second slot encoding module 15 may be a module that performs an operation of converting a ciphertext encoded in a form of a polynomial coefficient into a slot form in a form of a complex number vector.

The difference between the second slot encoding module 15 and the first slot encoding module 13 may be whether the scaling factor Δ is changed. It was described that the first slot encoding module 13 changes the scaling factor Δ. However, the second slot encoding module 15 may maintain the scaling factor Δ. The second slot encoding module 15 may output a slot-encoded ciphertext without changing the scaling factor Δ.

The second slot encoding module 15 may receive the fourth ciphertext (q₀I+Δ₂m+e₂) from the modulus expansion module 12. The second slot encoding module 15 may obtain a slot-encoded seventh ciphertext (q₀I+Δ₂m+e₂) as output data.

The scaling factor Δ₂ of the fourth ciphertext (q₀I+Δ₂m+e₂) and the scaling factor Δ₂ of the seventh ciphertext (q₀I+Δ₂m+e₂) may be identical.

The noise e₂ of the fourth ciphertext (q₀I+Δ₂m+e₂) and the noise e5 of the seventh ciphertext (q₀I+Δ₂m+e₂) may be different.

The subtraction module 16 may be a module for outputting a ciphertext wherein a modulus increased. Also, the subtraction module 16 may be a module that generates output data wherein a modulus of the input data was increased.

The subtraction module 16 may receive the sixth ciphertext (q₀I+e₄) from the integer conversion module 14. The subtraction module 16 may receive the seventh ciphertext (q₀I+Δ₂m+e₂) from the second slot encoding module 15. The subtraction module 16 may obtain an eighth ciphertext (Δ₁m+e₆) by subtracting the sixth ciphertext (q₀I+e₄) from the seventh ciphertext (q₀I+Δ₂m+e₂).

The subtraction module 16 may remove a value q₀I which is a result of multiplying a modulus q₀ added by the modulus expansion module 12 by a polynomial I.

The subtraction module 16 may change the scaling factor Δ. The subtraction module 16 may generate output data by the scaling factor Δ₁ identical to the scaling factor Δ₁ of the second ciphertext (Δ₁m+e₁) which is input data received by the bootstrapping module 112.

The scaling factor Δ₁ of the eighth ciphertext (Δ₁m+e₆) may be identical to the scaling factor Δ₁ of the second ciphertext (Δ₁m+e₁).

The noise e₆ of the eighth ciphertext (Δ₁m+e₆) may be different from the noise e₄ of the sixth ciphertext (q₀I+e₄).

The noise e₆ of the eighth ciphertext (Δ₁m+e₆) may be different from the noise e5 of the seventh ciphertext (q₀I+Δ₂m+e₂).

The noise of the eighth ciphertext (Δ₁m+e₆) may be

$$\frac{{Δ}_{1}}{{Δ}_{2}} \cdot ( {e}_{5} - {e}_{4} ) .$$

The modulus of the eighth ciphertext (Δ₁m+e₆) may be a bigger value than the modulus of the second ciphertext (Δ₁m+e₁). The electronic apparatus 100 may perform an additional operation action based on the eight ciphertext (Δ₁m+e₆) corresponding to the increased modulus.

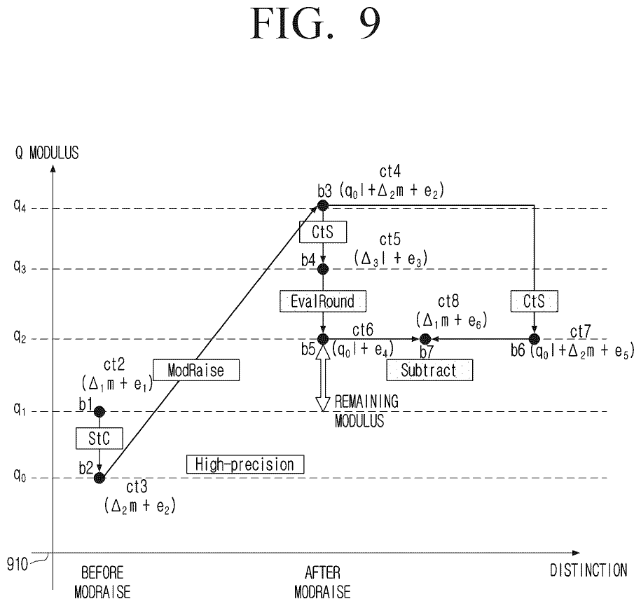

FIG. 9 is a diagram for illustrating a change of a modulus in a bootstrapping operation according to an embodiment.

Referring to the graph 910 in FIG. 9, the electronic apparatus 100 may perform bootstrapping for securing a modulus in homomorphic encryption.

The electronic apparatus 100 may obtain a second ciphertext (Δ₁m+e₁) corresponding to a modulus q₁ as a result of the operation action for homomorphic encryption (b1). The electronic apparatus 100 may determine that it is difficult for the modulus q₁ to perform an additional operation action. The electronic apparatus 100 may perform a bootstrapping operation for increasing the modulus.

The electronic apparatus 100 may obtain a third ciphertext (Δ₂m+e₂) by performing StC conversion for the second ciphertext (Δ₁m+e₁) (b2). The modulus q₀ of the third ciphertext (Δ₂m+e₂) may be a smaller value than the modulus q₁ of the second ciphertext (Δ₁m+e₁).

The electronic apparatus 100 may expand the modulus q₀ of the third ciphertext (Δ₂m+e₂). The electronic apparatus 100 may obtain a fourth ciphertext (q₀I+Δ₂m+e₂) by adding a value q₀I which is a result of multiplying the modulus q₀ with a polynomial I (b3). The modulus q₄ of the fourth ciphertext (q₀I+Δ₂m+e₂) may be a bigger value than the modulus q₀ of the third ciphertext (Δ₂m+e₂).

The electronic apparatus 100 may obtain a fifth ciphertext (Δ₃I+e₃) by performing CtS conversion for the fourth ciphertext (q₀I+Δ₂m+e₂) (b4). The modulus q₃ of the fifth ciphertext (Δ₃I+e₃) may be a smaller value than the modulus q₄ of the fourth ciphertext (q₀I+Δ₂m+e₂).

The electronic apparatus 100 may obtain a sixth ciphertext (q₀I+e₄) by performing integer conversion for the fifth ciphertext (Δ₃I+e₃) (b5). The modulus q₂ of the sixth ciphertext (q₀I+e₄) may be a smaller value than the modulus q₃ of the fifth ciphertext (Δ₃I+e₃).

The electronic apparatus 100 may obtain a seventh ciphertext (q₀I+Δ₂m+e₂) by performing CtS conversion for the fourth ciphertext (q₀I+Δ₂m+e₂) (b6). The modulus q₂ of the seventh ciphertext (q₀I+Δ₂m+e₂) may be a smaller value than the modulus q4 of the fourth ciphertext (q₀I+Δ₂m+e₂). Also, the modulus q₂ of the seventh ciphertext (q₀I+Δ₂m+e₂) may be a smaller value than the modulus q3 of the fifth ciphertext (Δ₃I+e₃). Further, the modulus q₂ of the seventh ciphertext (q₀I+Δ₂m+e₂) may be an identical value to the modulus q2 of the sixth ciphertext (q₀I+e₄).

The electronic apparatus 100 may obtain an eight ciphertext (Δ₁m+e₆) by performing a subtracting operation for the sixth ciphertext (q₀I+e₄) and the seventh ciphertext (q₀I+Δ₂m+e₂) (b7). The modulus q2 of the eight ciphertext (Δ₁m+e₆) may be an identical value to the modulus q₂ of the sixth ciphertext (q₀I+e₄). Also, the modulus q₂ of the eight ciphertext (Δ₁m+e₆) may be an identical value to the modulus q2 of the seventh ciphertext (q₀I+Δ₂m+e₂).

The electronic apparatus 100 may obtain an eight ciphertext (Δ₁m+e₆) having a bigger modulus q2 than the modulus q1 of the second ciphertext (Δ₁m+e₁) which is the initial input data. The electronic apparatus 100 may secure a modulus as much as the difference of the moduli (q₂/q₁). The electronic apparatus 100 may use the secured modulus as the remaining modulus. The electronic apparatus 100 may perform an additional operation action as much as the remaining modulus.

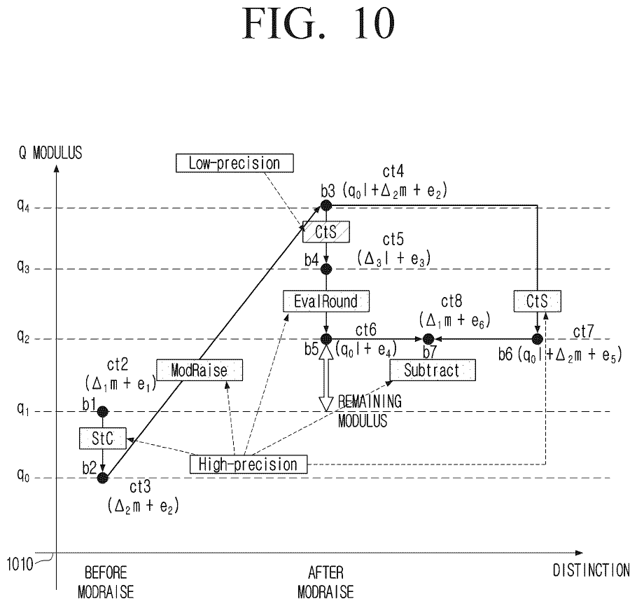

FIG. 10 is a diagram for illustrating an operation of controlling precision in a bootstrapping operation according to an embodiment.

The graph 1010 in FIG. 10 may correspond to the graph 910 in FIG. 9. Accordingly, overlapping explanation will be omitted.

The electronic apparatus 100 may obtain a fifth ciphertext (Δ₃I+e₃) by performing CtS conversion for the fourth ciphertext (q₀I+Δ₂m+e₂). The CtS conversion performed in this process may be described as first CtS conversion.

The electronic apparatus 100 may obtain a seventh ciphertext (q₀I+Δ₂m+e₂) by performing CtS conversion for the fourth ciphertext (q₀I+Δ₂m+e₂). The CtS conversion performed in this process may be described as second CtS conversion.

The electronic apparatus 100 may obtain the second ciphertext (Δ₁m+e₁) using the first scaling factor Δ₁.

The electronic apparatus 100 may use the second scaling factor Δ₂ for an StC converting operation, a modulus securing operation (ModRaise), an integer converting operation (EvalRound), a second CtS converting operation, and a subtracting operation in performing a bootstrapping operation.

The second scaling factor Δ₂ may be bigger than the first scaling factor Δ₁.

The electronic apparatus 100 may use the third scaling factor Δ₃ for the first CtS conversion.

The third scaling factor Δ₃ may be smaller than the second scaling factor Δ₂.

As the scaling factor Δ is bigger, operation complexity may increase. Accordingly, as the scaling factor Δ is bigger, precision (or accuracy) may increase.

The electronic apparatus 100 may use the third scaling factor Δ₃ which is relatively low only for the first CtS converting operation. In the case of using a relatively low scaling factor Δ, modulus consumption is reduced, and thus efficiency can be improved. Also, as a modulus is consumed less, the remaining modulus can be secured relatively more. Accordingly, the overall operation efficiency can be improved.

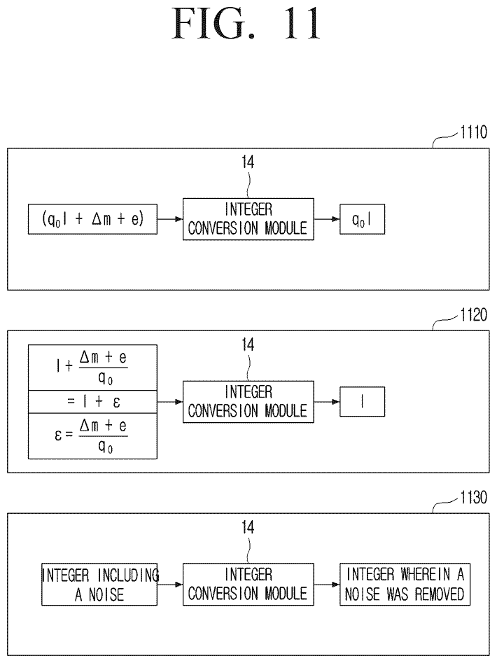

FIG. 11 is a diagram for illustrating an operation of converting an integer according to an embodiment.

Referring to the embodiment 1110 in FIG. 11, the electronic apparatus 100 may filter a second portion (Δm+e) but not the first portion (q₀I) indicating an integer in the ciphertext (q₀I+Δm+e) through the integer conversion module 14.

Referring to the embodiment 1120 in FIG. 11, the electronic apparatus 100 may filter a second portion

$$( \frac{Δ \cdot m + e}{{q}_{0}} )$$

but not the first portion (1) indicating an integer in the ciphertext

$$( I + \frac{Δ \cdot m + e}{{q}_{0}} )$$

through the integer conversion module 14.

Referring to the embodiment 1130 in FIG. 11, the electronic apparatus 100 may obtain an integer wherein a noise was removed based on an integer including a noise through the integer conversion module 14.

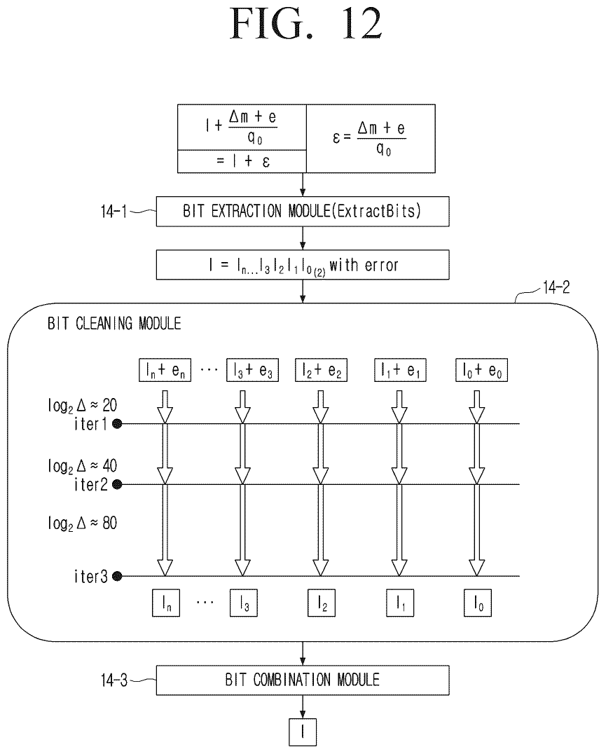

FIG. 12 is a diagram for illustrating a bit cleaning operation according to an embodiment.

Referring to FIG. 12, the integer conversion module 14 may include at least one of a bit extraction module 14-1, a bit extraction module 14-1, or a bit combination module 14-3.

The bit extraction module 14-1 may be a module that extracts a unit bit for a portion (I) indicating an integer in a ciphertext. Also, the bit extraction module 14-1 may be a module that extracts an integer value included in a ciphertext by dividing it into several small bit units (0 or 1). In the extracted unit bits, a noise may be included.

The bit extraction module 14-1 may perform a function of decomposing each coefficient of an integer polynomial included in a ciphertext in a form of a binary number, and separating each bit in a form of a ciphertext in this process and outputting them.

The bit cleaning module 14-2 may be a module that decreases noises (errors) mixed in extracted bits and organizes them to clean 0 or 1. The organizing operation may be repeated a plurality of times. In FIG. 12, it was described that three organizing operations are performed.

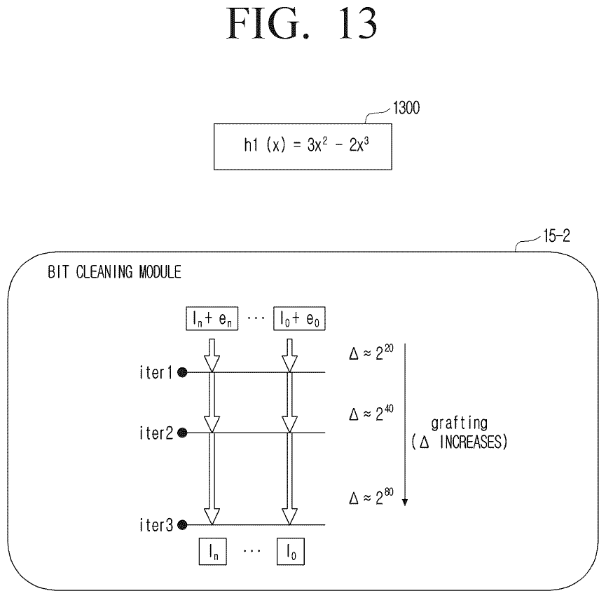

The bit cleaning module 14-2 may perform a function of organizing such that each bit becomes a value closer to 0 or 1 by using a purifying (cleaning) polynomial defined in advance for removing or reducing noises included in each extracted bit. A purifying polynomial will be described in FIG. 13.

The bit combination module 14-3 may be a module that puts together several organized bits again and makes them into one integer value. The bit combination module 14-3 may perform a function of combining purified bits into one integer polynomial again.

FIG. 13 is a diagram for illustrating a bit cleaning operation according to an embodiment.

The formula 1300 in FIG. 13 may indicate a purifying polynomial used in the bit cleaning module 14-2. A purifying polynomial may indicate a function that corrects an input value (x) to be close to 0 or 1 in case it is close to 0 or 1. A purifying polynomial may be, for example, a function for correcting a number such as 0.001 or 0.999 to 0 or 1.

As an example, the purifying polynomial may be h1(x)=3x²−2x³.

Whenever a purifying operation performed in the bit cleaning module 14-2 is repeatedly performed, the scaling factor Δ may increase.

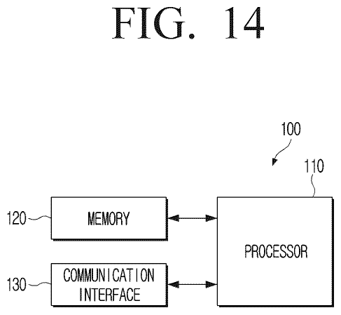

FIG. 14 is a block diagram illustrating an electronic apparatus according to an embodiment.

Referring to FIG. 14, an operation action of the electronic apparatus 100 according to an embodiment is explained.

Referring to FIG. 14, the at least one processor 110 may perform an operation for reducing noises included in a ciphertext.

The at least one processor 110 may obtain a scale factor Δ, Q and an input ciphertext (ct, Δx, Q) of a first modulus Q.

The at least one processor 110 may obtain a modified scale factor Δ, Q·A by expanding the scale factor Δ, Q to a second modulus Q·Δ.

The at least one processor 110 may obtain a modified input ciphertext (ct, Δx, Q·Δ) by expanding the input ciphertext (ct, Δx, Q) to the second modulus Q·Δ.

The at least one processor 110 may obtain a first sub ciphertext (ct1, Δ²x, Q·Δ) by multiplying the modified scale factor Δ, Q·A by the modified input ciphertext (ct, Δx, Q·Δ).

The at least one processor 110 may obtain a second sub ciphertext (ct2, Δ²x², Q/Δ) of a third modulus Q/Δ based on the first sub ciphertext (ct1, Δ²x, Q·Δ).

The at least one processor 110 may obtain a third sub ciphertext (ct3, Δ²x³, Q/Δ³) of a fourth modulus Q/Δ³ based on the first sub ciphertext (ct1, Δ²x, Q·Δ) and the second sub ciphertext (ct2, Δ²x², Q/Δ).

The at least one processor 110 may obtain a converted ciphertext (ct_out, Δ²(3x²−2x³), Q/Δ³) based on the second sub ciphertext (ct2, Δ²x², Q/Δ) and the third sub ciphertext (ct3, Δ²x³, Q/Δ³).

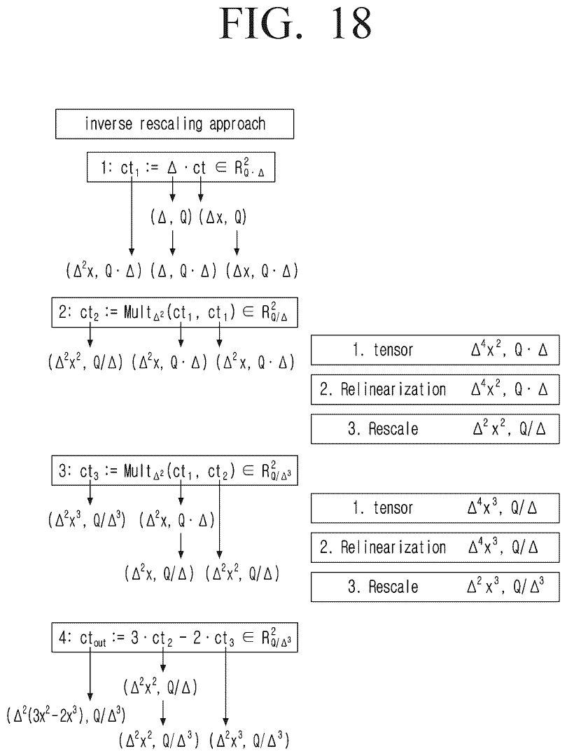

An operation of converting the input ciphertext (ct, Δx, Q) into the converted ciphertext (ct_out, Δ²(3x²−2x³), Q/Δ³) will be described in detail in FIG. 18.

As an example, the input ciphertext (ct, Δx, Q) may correspond to the fifth ciphertext (Δ²I+e₃) in FIG. 8. The converted ciphertext (ct_out, Δ²(3x²−2x³), Q/Δ³) may correspond to the sixth ciphertext (q0I+e₄) in FIG. 8.

The converted ciphertext (ct_out, Δ²(3x²−2x³), Q/Δ³) may be a ciphertext wherein noises decreased in the input ciphertext (ct, Δx, Q). Explanation in this regard will be described in FIG. 11.

The at least one processor 110 may decompose each coefficient of an integer polynomial included in the input ciphertext (ct, Δx, Q) into a unit bit in a form of a binary number, and obtain the converted ciphertext (ct_out, Δ²(3x²−2x³), Q/Δ³) wherein the noises in the unit bit decreased. Explanation in this regard will be described in FIG. 12 and FIG. 13.

The at least one processor 110 may obtain the second sub ciphertext (ct2, Δ²x², Q/Δ) by performing a homomorphic multiplication operation (mult) of the first sub ciphertext (ct1, Δ²x, Q·Δ) and the first sub ciphertext (ct1, Δ²x, Q·Δ).

The at least one processor 110 may obtain a first value Δ⁴x², Q·Δ by performing a polynomial multiplication (tensor) for the first sub ciphertext (ct1, Δ²x, Q·Δ) and the first sub ciphertext (ct1, Δ²x, Q·Δ).

The at least one processor 110 may obtain a second value Δ⁴x², Q·Δ by performing a relinearization operation for the first value Δ⁴x², Q·Δ.

The at least one processor 110 may obtain the second sub ciphertext (ct2, Δ²x², Q/Δ) by performing a rescale operation in a rescale unit Δ² for the second value Δ⁴x², Q·Δ.

The at least one processor 110 may obtain the third sub ciphertext (ct3, Δ²x³, Q/Δ³) by performing a homomorphic multiplication operation (mult) of the first sub ciphertext (ct1, Δ²x, Q·Δ) and the second sub ciphertext (ct2, Δ²x², Q/Δ).

The at least one processor 110 may obtain a first modified ciphertext (ct1, Δ²x, Q/Δ) by modifying the second modulus Q. A of the first sub ciphertext (ct1, Δ²x, Q·Δ) to the third modulus Q/Δ.

The at least one processor 110 may obtain the third sub ciphertext (ct3, Δ²x³, Q/Δ³) by performing a homomorphic multiplication operation (mult) of the first modified ciphertext (ct1, Δ²x, Q/Δ) and the second sub ciphertext (ct2, Δ²x², Q/Δ).

The at least one processor 110 may obtain a fourth value Δ⁴x³, Q/Δ by performing a polynomial multiplication (tensor) for the first modified ciphertext (ct1, Δ²x, Q/Δ) and the second sub ciphertext (ct2, Δ²x², Q/Δ).

The at least one processor 110 may obtain a fifth value Δ⁴x³, Q/Δ by performing a relinearization operation for the fourth value Δ⁴x³, Q/Δ.

The at least one processor 110 may obtain the third sub ciphertext (ct3, Δ²x³, Q/Δ³) by performing a rescale operation in a rescale unit Δ² for the fifth value Δ⁴x³, Q/Δ.

The at least one processor 110 may obtain the converted ciphertext (ct_out, Δ²(3x²−2x³), Q/Δ³) by applying the second sub ciphertext (ct2, Δ²x², Q/Δ) and the third sub ciphertext (ct3, Δ²x³, Q/Δ³) to a predetermined purified polynomial.

The at least one processor 110 may obtain a second modified ciphertext (ct2, Δ²x², Q/Δ³) by modifying the third modulus Q/Δ of the second sub ciphertext (ct2, Δ²x², Q/Δ) to the fourth modulus Q/Δ³.

The at least one processor 110 may obtain the converted ciphertext (ct_out, Δ²(3x²−2x³), Q/Δ³) by applying the second modified ciphertext (ct2, Δ²x², Q/Δ³) and the third sub ciphertext (ct3, Δ²x³, Q/Δ³) to the predetermined purified polynomial.

According to an embodiment, the predetermined polynomial may be h1(x)=3x²−2x³.

According to an embodiment, the operations disclosed in FIG. 14 may indicate the operations performed in the integer conversion module 14 in FIG. 8 and FIG. 11.

According to an embodiment, the operations disclosed in FIG. 14 may indicate the operations performed in the bit cleaning module 14-2 in FIG. 12 and FIG. 13.

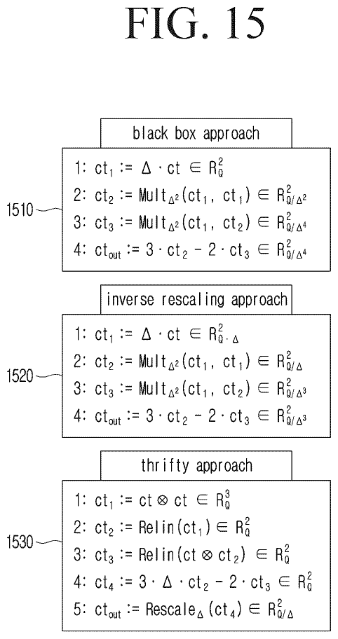

FIG. 15 is a diagram for illustrating a bit cleaning operation according to an embodiment.

The electronic apparatus 100 may perform a bit cleaning operation based on the algorithm disclosed in FIG. 15. As an example, a function for bit cleaning may be 3x²−2x³.

Referring to the embodiment 1510 in FIG. 15, the electronic apparatus 100 may obtain a first value ct1 by multiplying the ciphertext (ct) by the scaling factor Δ for a bit cleaning operation. Here, the modulus may be Q.

The electronic apparatus 100 may obtain a second value ct2 by applying a Mult function based on the first value ct1. Here, the modulus may be Q/Δ².

The Mult function may mean a homomorphic multiplication. Also, the Mult function may mean a homomorphic operation of multiplying two ciphertexts. The Mult function may be a function that receives inputs of two ciphertexts, and returns a result of multiplying them as a new ciphertext. Also, the Mult function may be a function that performs a relinearization operation for reducing a dimension of a multiplication result of a multiplication operation of two ciphertexts, and a rescale operation for normalizing a scaling factor that increased after a multiplication. The Mult function may perform a rescale operation as much as a defined scaling factor. In the embodiment 1510, the Mult function may perform a rescale operation as much as Δ².

The electronic apparatus 100 may obtain a third value ct3 by multiplying a Mult function based on the first value ct1 and the second value ct2. Here, the modulus may be Q/Δ⁴.

The electronic apparatus 100 may obtain an output value ct_out by calculating 3ct2-2ct3 based on the second value ct2 and the third value ct3. Here, the modulus may be Q/Δ⁴.

Referring to the embodiment 1520 in FIG. 15, the electronic apparatus 100 may obtain a first value ct1 by multiplying the ciphertext ct by the scaling factor Δ for a bit cleaning operation. Here, the modulus may be AQ.

The electronic apparatus 100 may obtain a second value ct2 by applying a Mult function based on the first value ct1. Here, the modulus may be Q/Δ.

The electronic apparatus 100 may obtain a third value ct3 by applying a Mult function based on the first value ct1 and the second value ct2. Here, the modulus may be Q/Δ³.

The electronic apparatus 100 may obtain an output value ct_out by calculating 3ct2-2ct3 based on the second value ct2 and the third value ct3. Here, the modulus may be Q/Δ³.

Referring to the embodiment 1530 in FIG. 15, the electronic apparatus 100 may obtain a first value ct1 by performing a multiplication operation of the ciphertext (ct) and the ciphertext (ct). Here, the modulus may be Q.

The electronic apparatus 100 may obtain a second value ct2 by performing relinearization for the first value ct1. Here, the modulus may be Q.

The electronic apparatus 100 may obtain a third value ct3 by performing relinearization for a multiplication operation of the ciphertext (ct) and the second value ct2. Here, the modulus may be Q.

The electronic apparatus 100 may obtain a fourth value ct4 by calculating 3Δct2−2ct3 based on the second value ct2 and the second value ct2. Here, the modulus may be Q/Δ³.

The electronic apparatus 100 may obtain an output value ct_out by performing rescale as much as A for the fourth value ct4. Here, the modulus may be Q/Δ.

The modulus of the output value ct_out obtained in the embodiment 1510 in FIG. 15 may be Q/Δ⁴. The modulus of the output value ct_out obtained in the embodiment 1520 in FIG. 15 may be Q/Δ³. The modulus of the output value ct_out obtained in the embodiment 1530 in FIG. 15 may be Q/Δ. The embodiment 1520 may secure a modulus more than the embodiment 1510 as much as Δ. The embodiment 1530 may secure a modulus more than the embodiment 1510 as much as Δ².

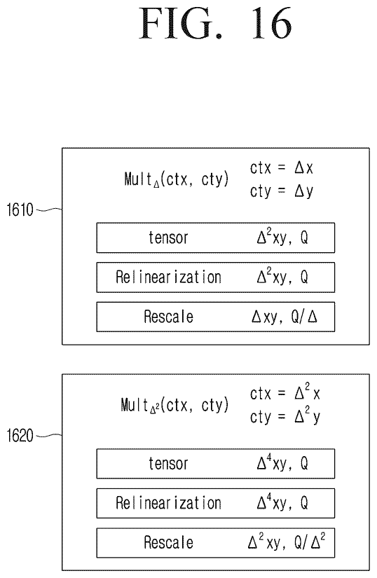

FIG. 16 is a diagram for illustrating a Mult function according to an embodiment.

The Mult function may mean a homomorphic multiplication. Also, the Mult function may mean a homomorphic operation of multiplying two ciphertexts. The Mult function may be a function that receives inputs of two ciphertexts, and returns a result of multiplying them as a new ciphertext.

The Mult function may perform a multiplication operation (tensor) of two ciphertexts, a relinearization operation for reducing a dimension of a multiplication result, and a rescale operation for normalizing a scaling factor that increased after a multiplication. The Mult function may indicate an operation of performing the three types of operations in order.

The embodiment 1510 in FIG. 16 indicates a Mult function for a rescale unit A. A first ciphertext (Δx) and a second ciphertext (Δy) are assumed. The electronic apparatus 100 may apply the Mult function to the first ciphertext (Δx) and the second ciphertext (Δy). The electronic apparatus 100 may obtain a first value Δ²xy by performing a multiplication operation (tensor) for the first ciphertext (Δx) and the second ciphertext (Δy). Here, the modulus may be Q.

The electronic apparatus 100 may obtain a second value Δ²xy by performing a relinearization operation for the first value Δ²xy. The second value Δ²xy may be a linearized value. Here, the modulus may be Q.

The electronic apparatus 100 may obtain a third value Δxy by performing a rescale operation in the rescale unit A for the second value Δ²xy. Here, the modulus may be Q/Δ.

The embodiment 1620 in FIG. 16 indicates a Mult function for a rescale unit Δ². A first ciphertext (Δ²x) and a second ciphertext (Δ²y) are assumed. The electronic apparatus 100 may apply the Mult function to the first ciphertext (Δ²x) and the second ciphertext (Δ²y). The electronic apparatus 100 may obtain a first value Δ⁴xy by performing a multiplication operation (tensor) for the first ciphertext (Δ²x) and the second ciphertext (Δ²y). Here, the modulus may be Q.

The electronic apparatus 100 may obtain a second value Δ⁴xy by performing a relinearization operation for the first value Δ⁴xy. The second value Δ⁴xy may be a linearized value. Here, the modulus may be Q.

The electronic apparatus 100 may obtain a third value Δ²xy by performing a rescale operation in the rescale unit Δ² for the second value Δ⁴xy. Here, the modulus may be Q/Δ².

The first ciphertext and the second ciphertext described in FIG. 16 are for indicating individual ciphertexts, and they may be different from the first ciphertext and the second ciphertext disclosed in FIG. 8.

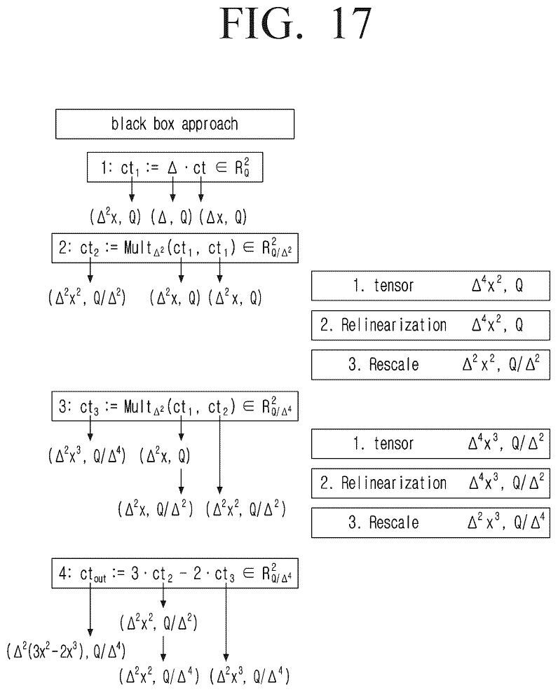

FIG. 17 is a diagram for illustrating a bit cleaning operation according to an embodiment.

FIG. 17 is a diagram for illustrating the embodiment 1510 in FIG. 15.

The electronic apparatus 100 may apply a ciphertext to a predetermined function for a bit cleaning operation. As an example, the predetermined function (a purified polynomial) may be h1(x)=3x²−2x³.

In FIG. 17, the ciphertext may be described in a format of (a1, a2, a3). a1 may be identification information for distinguishing the ciphertext. a2 may be information indicating a value included in the ciphertext. a3 may indicate a modulus.

In FIG. 17, a median calculation value may be described in a format of (a2, a3). a2 may indicate a calculation value. a3 may indicate a modulus.

FIG. 17 may indicate a bit cleaning operation performed in the integer conversion module 14 disclosed in FIG. 8. The input ciphertext (ct, Δx, Q) may correspond to the fifth ciphertext (Δ²I+e3) in FIG. 8. The converted ciphertext (ct_out, Δ²(3x²−2x³), Q/Δ⁴) may correspond to the sixth ciphertext (q0I+e4) in FIG. 8. When the bit cleaning operation disclosed in FIG. 17 is performed, the scale factor may be changed from A to Δ². Accordingly, (Δ²)2 may be q0.

The electronic apparatus 100 may obtain a first sub ciphertext (ct1, Δ²x, Q) by multiplying the scale factor Δ, Q by the input ciphertext (ct, Δx, Q).

The electronic apparatus 100 may obtain a second sub ciphertext (ct2, Δ²x², Q/Δ²) by applying the Mult function to the first sub ciphertext (ct1, Δ²x, Q) and the first sub ciphertext (ct1, Δ²x, Q).

The electronic apparatus 100 may obtain a first value Δ⁴x², Q by performing a multiplication operation (tensor) for the first sub ciphertext (ct1, Δ²x, Q) and the first sub ciphertext (ct1, Δ²x, Q).

The electronic apparatus 100 may obtain a second value Δ⁴x², Q by performing a relinearization operation for the first value Δ⁴x², Q.

The electronic apparatus 100 may obtain a third value Δ²x², Q/Δ² by performing a rescale operation in a rescale unit Δ² for the second value Δ⁴x², Q.

The electronic apparatus 100 may obtain the third value Δ²x², Q/Δ² as the second sub ciphertext (ct2, Δ²x², Q/Δ²).

The electronic apparatus 100 may obtain a third sub ciphertext (ct3, Δ²x³, Q/Δ⁴) by applying the Mult function to the first sub ciphertext (ct1, Δ²x, Q) and the second sub ciphertext (ct2, Δ²x², Q/Δ²).

The moduli of the first sub ciphertext (ct1, Δ²x, Q) and the second sub ciphertext (ct2, Δ²x², Q/Δ²) may be different. For making the moduli coincide, the electronic apparatus 100 may convert the first sub ciphertext (ct1, Δ²x, Q) into a first modified ciphertext (ct1, Δ²x, Q/Δ²). The electronic apparatus 100 may obtain the third sub ciphertext (ct3, Δ²x³, Q/Δ⁴) by applying the Mult function to the first modified ciphertext (ct1, Δ²x, Q/Δ²) and the second sub ciphertext (ct2, Δ²x², Q/Δ²).

The electronic apparatus 100 may obtain a fourth value Δ⁴x³, Q/Δ² by performing a multiplication operation (tensor) for the first modified ciphertext (ct1, Δ²x, Q/Δ²) and the second sub ciphertext (ct2, Δ²x², Q/Δ²).

The electronic apparatus 100 may obtain a fifth value Δ⁴x³, Q/Δ² by performing a relinearization operation for the fourth value Δ⁴x³, Q/Δ².

The electronic apparatus 100 may obtain a sixth value Δ²x³, Q/Δ⁴ by performing a rescale operation in the rescale unit Δ² for the fifth value Δ⁴x³, Q/Δ².

The electronic apparatus 100 may obtain the sixth value Δ²x³, Q/Δ⁴ as the third sub ciphertext (ct3, Δ²x³, Q/Δ⁴).

The electronic apparatus 100 may obtain the converted ciphertext (ct_out, Δ²(3x²−2x³), Q/Δ⁴) by applying the purified polynomial h1(x)=3x²−2x³ to the second sub ciphertext (ct2, Δ²x², Q/Δ²) and the third sub ciphertext (ct3, Δ²x³, Q/Δ⁴).

The moduli of the second sub ciphertext (ct2, Δ²x², Q/Δ²) and the third sub ciphertext (ct3, Δ²x³, Q/Δ⁴) may be different. For making the moduli coincide, the electronic apparatus 100 may convert the second sub ciphertext (ct2, Δ²x², Q/Δ²) into a second modified ciphertext (ct2, Δ²x², Q/Δ⁴). The electronic apparatus 100 may obtain the converted ciphertext (ct_out, Δ²(3x²−2x³), Q/Δ⁴) by applying the purified polynomial h1(x)=3x²−2x³ to the second modified ciphertext (ct2, Δ²x², Q/Δ⁴) and the third sub ciphertext (ct3, Δ²x³, Q/Δ⁴).

FIG. 18 is a diagram for illustrating a bit cleaning operation according to an embodiment.

FIG. 18 is a diagram for illustrating the embodiment 1520 in FIG. 15.

The electronic apparatus 100 may apply a ciphertext to a predetermined function for a bit cleaning operation. As an example, the predetermined function (a purified polynomial) may be h1(x)=3x²−2x³.

In FIG. 18, the ciphertext may be described in a format of (a1, a2, a3). a1 may be identification information for distinguishing the ciphertext. a2 may be information indicating a value included in the ciphertext. a3 may indicate a modulus.

In FIG. 18, a median calculation value may be described in a format of (a2, a3). a2 may indicate a calculation value. a3 may indicate a modulus.

FIG. 18 may indicate a bit cleaning operation performed in the integer conversion module 14 disclosed in FIG. 8. The input ciphertext (ct, Δx, Q) may correspond to the fifth ciphertext (Δ²I+e₃) in FIG. 8. The converted ciphertext (ct_out, Δ²(3x²−2x³), Q/Δ³) may correspond to the sixth ciphertext (q0I+e₄) in FIG. 8. When the bit cleaning operation disclosed in FIG. 18 is performed, the scale factor may be changed from Δ to Δ². Accordingly, (Δ²) 2 may be q₀.

The electronic apparatus 100 may obtain a first sub ciphertext (ct1, Δ²x, Q·Δ) by multiplying the scale factor Δ, Q by the input ciphertext (ct, Δx, Q).

The electronic apparatus 100 may change the modulus of the scale factor Δ, Q and the input ciphertext (ct, Δx, Q). The electronic apparatus 100 may expand the modulus of the scale factor Δ and the input ciphertext (ct, Δx, Q) to Q·Δ.

The electronic apparatus 100 may convert the scale factor Δ, Q into a modified scale factor Δ, Q·Δ. The electronic apparatus 100 may convert the input ciphertext (ct, Δx, Q) into a modified input ciphertext (ct, Δx, Q·Δ). The electronic apparatus 100 may obtain a first sub ciphertext (ct1, Δ²x, Q·Δ) by multiplying the modified scale factor Δ, Q·Δ by the modified input ciphertext (ct, Δx, Q·Δ).

The electronic apparatus 100 may obtain a second sub ciphertext (ct2, Δ²x², Q/Δ) by applying the Mult function to the first sub ciphertext (ct1, Δ²x, Q·Δ) and the first sub ciphertext (ct1, Δ²x, Q·Δ).

The electronic apparatus 100 may obtain a first value 4x², Q A by performing a multiplication operation (tensor) for the first sub ciphertext (ct1, Δ²x, Q·Δ) and the first sub ciphertext (ct1, Δ²x, Q·Δ).

The electronic apparatus 100 may obtain a second value Δ⁴x², Q·Δ by performing a relinearization operation for the first value 4x², Q·Δ.

The electronic apparatus 100 may obtain a third value Δ²x², Q/Δ by performing a rescale operation in a rescale unit 42 for the second value Δ⁴x², Q·Δ.

The electronic apparatus 100 may obtain the third value Δ²x², Q/Δ as the second sub ciphertext (ct2, Δ²x², Q/Δ).

The electronic apparatus 100 may obtain a third sub ciphertext (ct3, Δ²x³, Q/Δ³) by applying the Mult function to the first sub ciphertext (ct1, Δ²x, Q·Δ) and the second sub ciphertext (ct2, Δ²x², Q/Δ).

The moduli of the first sub ciphertext (ct1, Δ²x, Q·Δ) and the second sub ciphertext (ct2, Δ²x², Q/Δ) may be different. For making the moduli coincide, the electronic apparatus 100 may convert the first sub ciphertext (ct1, Δ²x, Q·Δ) into a first modified ciphertext (ct1, Δ²x, Q/Δ). The electronic apparatus 100 may obtain a third sub ciphertext (ct3, Δ²x³, Q/Δ³) by applying the Mult function to the first modified ciphertext (ct1, Δ²x, Q/Δ) and the second sub ciphertext (ct2, Δ²x², Q/Δ).

The electronic apparatus 100 may obtain a fourth value Δ⁴x³, Q/Δ by performing a multiplication operation (tensor) for the first modified ciphertext (ct1, Δ²x, Q/Δ) and the second sub ciphertext (ct2, Δ²x², Q/Δ).

The electronic apparatus 100 may obtain a fifth value Δ⁴x³, Q/Δ by performing a relinearization operation for the fourth value Δ⁴x³, Q/Δ.

The electronic apparatus 100 may obtain a sixth value Δ²x³, Q/Δ³ by performing a rescale operation in the rescale unit Δ² for the fifth value Δ⁴x³, Q/Δ.

The electronic apparatus 100 may obtain the sixth value Δ²x³, Q/Δ³ as the third sub ciphertext (ct3, Δ²x³, Q/Δ³).

The electronic apparatus 100 may obtain a converted ciphertext (ct_out, Δ²(3x²−2×3), Q/Δ³) by applying a purified polynomial h1(x)=3x²−2x³ to the second sub ciphertext (ct2, Δ²x², Q/Δ) and the third sub ciphertext (ct3, Δ²x³, Q/Δ³).

The moduli of the second sub ciphertext (ct2, Δ²x², Q/Δ) and the third sub ciphertext (ct3, Δ²x³, Q/Δ³) may be different. For making the moduli coincide, the electronic apparatus 100 may convert the second sub ciphertext (ct2, Δ²x², Q/Δ) into a second modified ciphertext (ct2, Δ²x², Q/Δ³). The electronic apparatus 100 may obtain the converted ciphertext (ct_out, Δ²(3x²−2x³), Q/Δ³) by applying the purified polynomial h1(x)=3x²−2x³ to the second modified ciphertext (ct2, Δ²x², Q/Δ³) and the third sub ciphertext (ct3, Δ²x³, Q/Δ³).

The modulus of the converted ciphertext in FIG. 17 may be Q/Δ⁴, and the modulus of the converted ciphertext in FIG. 18 may be Q/Δ³. The modulus of the converted ciphertext in FIG. 18 may be bigger than the modulus of the converted ciphertext in FIG. 17 as much as Δ. Accordingly, the electronic apparatus 100 may secure the modulus as much as Δ.

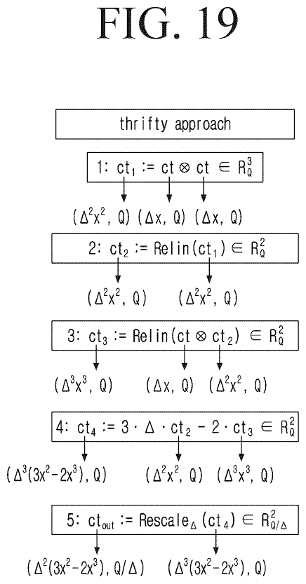

FIG. 19 is a diagram for illustrating a bit cleaning operation according to an embodiment.

FIG. 19 is a diagram for illustrating the embodiment 1530 in FIG. 15.

The electronic apparatus 100 may apply a ciphertext to a predetermined function for a bit cleaning operation. As an example, the predetermined function (a purified polynomial) may be h2(x)=34x²−2x³. The purified polynomial may be partially different from FIG. 17 and FIG. 18.

In FIG. 19, the ciphertext may be described in a format of (a1, a2, a3). a1 may be identification information for distinguishing the ciphertext. a2 may be information indicating a value included in the ciphertext. a3 may indicate a modulus.

In FIG. 19, a median calculation value may be described in a format of (a2, a3). a2 may indicate a calculation value. a3 may indicate a modulus.

FIG. 19 may indicate a bit cleaning operation performed in the integer conversion module 14 disclosed in FIG. 8. The input ciphertext (ct, Δx, Q) may correspond to the fifth ciphertext (Δ²I+e₃) in FIG. 8. The converted ciphertext (ct_out, Δ²(3x²−2x³), Q/Δ) may correspond to the sixth ciphertext (q0I+e₄) in FIG. 8. When the bit cleaning operation disclosed in FIG. 19 is performed, the scale factor may be changed from Δ to Δ². Accordingly, (Δ²) 2 may be q₀.

The electronic apparatus 100 may obtain a first sub ciphertext (ct1, Δ²x², Q) by performing a multiplication operation for the input ciphertext (ct, Δx, Q) and the input ciphertext (ct, Δx, Q).

The electronic apparatus 100 may obtain a second sub ciphertext (ct2, Δ²x², Q) by performing a relinearization operation for the first sub ciphertext (ct1, Δ²x², Q).

The electronic apparatus 100 may obtain a third sub ciphertext (ct3, Δ²x³, Q) by performing a relinearization operation for the multiplication result value of the input ciphertext (ct, Δx, Q) and the second sub ciphertext (ct2, Δ²x², Q).

The electronic apparatus 100 may obtain a fourth sub ciphertext (ct4, Δ²(3x²−2x³), Q) by applying the purified polynomial h2(x)=34x²−2×3 to the second sub ciphertext (ct2, Δ²x², Q) and the third sub ciphertext (ct3, Δ²x³, Q).

The electronic apparatus 100 may obtain a converted ciphertext (ct_out, Δ²(3x²-2x³), Q/Δ) by performing a rescale operation in a rescale unit A for the fourth sub ciphertext (ct4, Δ²(3×2−2x³), Q).

The modulus of the converted ciphertext in FIG. 17 may be Q/Δ⁴, and the modulus of the converted ciphertext in FIG. 18 may be Q/Δ³. The modulus of the converted ciphertext in FIG. 19 may be Q/Δ. The modulus of the converted ciphertext in FIG. 19 may be bigger than the modulus of the converted ciphertext in FIG. 17 as much as Δ². Accordingly, the electronic apparatus 100 may secure the modulus as much as Δ². Also, the modulus of the converted ciphertext in FIG. 19 may be bigger than the modulus of the converted ciphertext in FIG. 18 as much as Δ². Accordingly, the electronic apparatus 100 may secure the modulus as much as Δ².

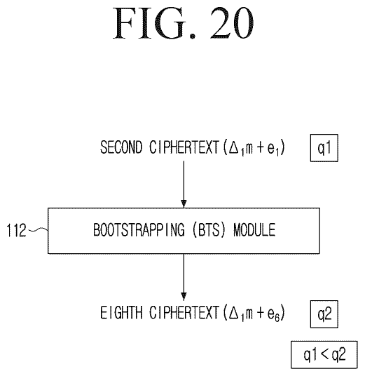

FIG. 20 is a diagram for illustrating a bootstrapping operation according to an embodiment.

Referring to FIG. 20, the electronic apparatus 100 may increase the modulus through a bootstrapping module 112. The bootstrapping module 112 may output the eighth ciphertext (Δ1m+e6) of the second modulus q2 based on the second ciphertext (Δ1m+e1) of the first modulus q1. The second modulus q2 may be bigger than the first modulus q1.

### INTRODUCTION

CKKS is one of the most popular Fully Homomorphic Encryption (FHE) schemes, in particular when it comes to computations on real numbers. These real numbers are in fact computed upon with some precision, similarly to fixed-point arithmetic. This precision can be parameterized, with homomorphic computations getting more expensive with higher precision. In many secure delegations of computations, such as inference and training in privacy-preserving machine learning, a moderate precision suffices. For instance, the main libraries providing implementations of CKKS all provide a precision of ≈20 bits as a default option or one of the default options. This precision choice is in part guided by its compatibility with 64-bit integer computations when using RNS-CKKS. In this work, we instead focus on higher precision computations.

In the context of FHE over real numbers, high precisions may arise for specific computations that also require very high accuracy when performed in clear, for example in the case of numerically unstable tasks. However, more commonly, the need of high precision in FHE computations stems from the use of stronger security properties than IND-CPA security or extended functionality. Let us mention three such security properties. First, circuit privacy requires that the decryptor should not be able to grasp information about the evaluated circuit beyond what it can get by making evaluation requests; this can be a desirable property to protect model weights in secure inference. Second, IND-CPA-D security requires that the scheme retains IND-CPA security even if the adversary can see the plaintexts obtained by decrypting legitimately formed ciphertexts; this is particularly relevant if the client publishes the result of the computation it securely delegated, such as models obtained from sensitive data but that are meant to be publicly used. Finally, in the case of Threshold-FHE and related notions (see, e.g.), the decryption key is secret-shared among users and one requires that the scheme retains IND-CPA security even if the adversary corrupted some fraction of the secret key share-holders. In all these cases, the only known general-purpose solutions for CKKS rely on exponential noise flooding: as the decryption noise contains sensitive information, one hides it by adding a statistically fresh noise to it, which is exponentially larger as a function of the security parameter λ. Why does it lead to using high-precision computations in CKKS? In CKKS, noise and plaintext are tied together: the real-valued plaintext is known up to some accuracy, and the inaccuracy is the noise. Therefore, to hide the noise with exponential noise flooding while retaining useful information in the most significant plaintext bits, one aims at a relative error (before flooding) that is exponentially smaller than the plaintext values, or, put differently, a numerical precision that grows linearly in λ. If the data consists of very small integers, then it may be made more accurate thanks to cleaning. Otherwise, one is led to using a high precision throughout the whole computation, from the very start. Concretely, depending on the bit-security that one aims to obtain with flooding, one can typically request from 40 to 64 extra bits of precision, on top of the desired output precision.

Handling such large precisions in CKKS has proved challenging. The main difficulty comes from the modulus consumption of bootstrapping. In CKKS, a ciphertext (resp. evaluation key) is an element (resp. a family of elements) of R where R_{q}=Z_{q} [x]/(x^{N}+1) for an integer q>1 and a power-of-two integer N>1. The ciphertext modulus q evolves during homomorphic evaluation: every homomorphic multiplication decreases q by a factor≈2^{t}·C, where t is the plaintext precision and C depends on other scheme parameters. To ensure that the Ring-LWE instances provide sufficient security, for any value of N, the modulus q cannot exceed some amount. For example, for N=2¹⁶, the bit-size of q should be at most≈1600, the exact value depending on the specific Ring-LWE parametrization. To enable arbitrarily long computations, CKKS bootstrapping takes as input a ciphertext with a small modulus and maps it to a ciphertext that decrypts to the same plaintext, up to some small error, but defined over a much larger modulus. Despite numerous works on CKKS bootstrapping (see, among others,), state-of-the-art bootstrapping still requires of the order of 20 multiplicative levels (including auxiliary modulus used in key switching) and consumes of the order of 1150 bits for a plaintext precision t≈20 bits (see, e.g.,). Increasing t by 40 to 64 bits would increase bootstrapping modulus consumption by 800 to 1280 bits. Proceeding in this way is incompatible with taking N=2¹⁶, as the required modulus is too large for Ring-LWE security; this can be accommodated by increasing the Ring-LWE degree, but with a significant performance impact. An alternative to increasing the plaintext precision is to simulate high-precision plaintexts using smaller-precision plaintexts, like in arbitrary-precision real number software. This can be realized homomorphically using the tuple-CKKS method introduced in: concretely, increasing the precision from 20 to 20+40=60 or 20+60=80 bits can be achieved by representing plaintexts with 3 or 4 ciphertexts with 20-bit precision each. This allows to lower the modulus consumption, perhaps making it possible to bootstrap high plaintext precisions with N=2¹⁶, at the expense of manipulating more ciphertexts in parallel. Finally, the high-precision bootstrapping algorithm from, available in, takes a different route. It consists in running small-precision bootstrapping several times sequentially, to progressively increase the precision of the result. Combined with tuple-CKKS or composite rescaling in RNS-CKKS, this provides a full-fledged solution for high-precision CKKS. For 60 to 80 bits of plaintext precision, it however requires at least 3 to 4 sequential 20-bit bootstraps.

In all the above approaches, increasing the plaintext precision from a constant to t bits leads to an increase of the bootstrapping cost by (at least) a factor O(t). Can we bootstrap in high plaintext precision with a lower cost penalty?

Contributions. We introduce a novel bootstrapping algorithm that significantly improves the performance of CKKS bootstrapping in the case of high-precision plaintexts. Compared to the previous approaches, its cost and modulus penalties compared to small precision bootstrapping is almost only additive rather than multiplicative. In more details, CKKS bootstrapping algorithms all consist of homomorphic Discrete Fourier Transformations called coeffs-to-slots (CtS) and slots-to-coeffs (StC), and of a non-linear component that can come in several flavors. In our case, out of these three main bootstrapping components, only the modulus consumption of the cheapest one, StC, grows linearly in t where t is the plaintext precision. The cost and modulus consumption of CtS do not increase with t, and those of the non-linear bootstrapping components grow slowly with t (modulus consumption increases by an additive term O(t) as opposed to a multiplicative factor).

Our algorithm builds upon the EvalRound/EvalRound+bootstrapping algorithms. These differ from other bootstrapping algorithms in their non-linear component: instead of evaluating a modular reduction I+x= [symbol] x where I is a bounded integer and x a real number with |x|«1 (EvalMod), they evaluate the rounding function I+x= [symbol] I (EvalRound). This reduces the modulus consumption of CtS. These works however implement EvalRound as id—EvalMod. Our main technical ingredient is a new EvalRound algorithm whose cost and modulus consumption depend only additively in the plaintext precision. For this purpose, we borrow and improve techniques introduced for handling discrete data with CKKS: indeed, the plaintext I+x is a noisy representation of a small integer I. We break I into pieces, to reduce the task to increasing the precision of bits (elements of {0,1}) or trits (elements of {−1,0,1}): when the plaintext precision increases, this requires high precision only in the final steps.

We further investigate the bit/trit cleaning step, as it is a significant contributor to the total modulus consumption of our bootstrapping algorithm. We implement it by repeatedly evaluating a precision-doubling polynomial. The polynomials we choose require multiplicative depth two. As a result, if the plaintext precision increases from t to ≈2t, then a black-box implementation—from homomorphic addition, multiplication and conjugation—consumes 4t bits of modulus (i.e., 2^{t} bits per multiplicative level). Instead, we open the black-box and use the sub-components of homomorphic multiplication to design an evaluation of these polynomials that consumes only t bits of modulus. In practice, this improvement saves hundreds of bits in modulus consumption.

Implementation and Experiments. We implemented our algorithm using a version of the HEaaN library that relies on the recent grafting technique from. This technique is particularly useful as our algorithm relies on many different (small and large) precisions. We note that this is an experimental code, and its efficiency can most likely be improved further. It should however provide a meaningful comparison to the state-of-the-art approach, Meta-BTS, as we estimate its time based on our implementation.

The concrete modulus consumption of our algorithm for ring degree N=2¹⁶ is highlighted in Table 1, for plaintext precisions ranging from 20 to 80 bits. In particular, it is the first time that a high-precision non-iterative bootstrap is reported in ring degree N=2¹⁶ The timings of the first four rows are in single-thread CPU (Δpple M4 Pro, 32GiB RAM), using the same code-base; the data of the fifth row is extrapolated from the fourth; we do not give timings for the last row as uses a different (less efficient) code-base. The first three parameter sets correspond to our algorithm, FGb* is a modified parameter set of that provides similar failure probability≈2⁻¹²⁸ as our parameter sets.

Modulus consumptions and execution times for various CKKS bootstrapping algorithms. “Prec.” refers to the precision of the bootstrap, while “Available modulus” refers to the modulus that is left after bootstrapping.

| | Cleaning | | Available | Time | Modulus/ |
|---|---|---|---|---|---|
| Parameter set | iterations | Prec. | modulus | (s) | Time |
| Direct2Cln19 | 2 | 19 | 742 | 14.3 | 51.8 |
| Direct2Cln38 | 2 | 38 | 640 | 17.9 | 35.8 |
| Direct3Cln81 | 3 | 81 | 494 | 20.9 | 23.7 |
| FGb* | — | 21 | 550 | 8.5 | 64.6 |
| FGb* | — | ≅40 | 530 | 17.0 | 31.1 |
| Meta-BTS × 2 | | | | | |
| FGb* | — | ≅80 | 490 | 34.0 | 14.4 |
| Meta-BTS × 4 | | | | | |
| EvalRound+ | — | 16 | 546 | — | — |
| [SSKM24] | | | | | |

table 1: Modulus consumptions and execution times for various CKKS bootstrapping algorithms. “Prec.” refers to the precision of the bootstrap, while “Available modulus” refers to the modulus that is left after bootstrapping.

### Technical Overview

Consider a ciphertext (a, b) ∈

$${ℛ}_{{q}_{0}}^{2}$$

such that a·s+b≈Δ·m mod q₀, where s ∈ [symbol] = [symbol] [x]/(x^{N}+1) is the secret key, Δ«q₀ is a scaling factor growing as C. 2^{t} for plaintext precision t and with C depending on other scheme parameters, and m ∈[−1,1]^{N} is the plaintext. CKKS bootstrapping regains modulus by viewing (a, b) as a no-modulus ciphertext: there exists I ∈ R such that a·s+b=q₀·I+Δ·m over R and hence over R_{Q} for any Q>1. This re-interpretation of (a, b) is called ModRaise. The rest of CKKS bootstrapping aims at removing q₀·I from q₀·I+Δ·m while approximately keeping m, to obtain a high-modulus ciphertext of m. Classical CKKS bootstrapping achieves it by viewing q₀·I+Δ·m as a higher-precision plaintext and performing a homomorphic reduction modulo q₀ implemented with a polynomial approximation.

Extending the above to high-precision plaintexts leads to higher precision computations all throughout bootstrapping, as the bootstrapping plaintexts should be sufficiently precise to keep m accurate in q₀·I+Δ·m. Instead, we start from the observation from that it suffices to bootstrap I to bootstrap m. Indeed, given (a, b) ∈ R² and (a′, b′) ∈

$${ℛ}_{Q}^{2}$$

such that

$$a \cdot s + b = {q}_{0} \cdot I + Δ \cdot m and {a}^{′} \cdot s + {b}^{′} \approx {q}_{0} \cdot I mod Q ,$$

$$then ( a - {a}^{′} , b - {b}^{′} ) ∈ {ℛ}_{Q}^{2} satisfies$$

$$( a - {a}^{′} ) \cdot s + ( b - {b}^{′} ) \approx Δ \cdot m mod Q .$$

Note that the plaintext precision of (a′, b′) must be sufficiently high so that m is accurately stored in (a-a′, b-b′). Bootstrapping/is considered in to reduce a CKKS bootstrap to N bootstraps of DM/CGGI ciphertexts. Because of the magnitude of N, this is mostly of theoretical interest. In, bootstrapping I is used to reduce the plaintext precision of the first bootstrapping component that follows ModRaise, namely CtS. To see this, recall that the native CKKS operations operate on slots (i.e., in the Fourier domain), and that the purpose of CtS is to bring q₀·I+Δ·m (resp. q₀·1) from the coefficients to the slots, so that subsequent slots operations can remove I (resp. increase the accuracy of I). After CtS, the bootstrapping algorithms from however use high plaintext precision all-throughout its EvalRound procedure to obtain the ciphertext (a′, b′) above.

Let us now see how EvalRound can be implemented. Recall that the goal is to start from a ciphertext encrypting/with low accuracy (in the slots) and obtain a ciphertext (a′, b′) also decrypting to/but with high accuracy. In, this is achieved using id—EvalMod, where EvalMod is the modular reduction function from conventional CKKS bootstrapping, which uses for all its steps a plaintext precision that is no smaller than the target precision. This approach ignores that/is a small integer. For example, using the sparse secret encapsulation technique from, for N=2¹⁶, we have that ∥I∥_{∞}≤15 with probability extremely close to 1, under the assumption that the a-part of the ciphertext to be bootstrapped in uniformly distributed. In fact, increasing the accuracy of an integer/has been independently considered as a specific task in, which focused on manipulating discrete data with CKKS: increasing the precision of I is viewed as a cleaning process, allowing further discrete data computations.

We also view EvalRound as an integer cleaning process, but rely on a different algorithm from. In that work, the authors extract the most significant bit using a sign function evaluation, then clean that bit, subtract it from the integer and continue with the next most significant bit. The use of and the sequential aspect incur huge multiplicative depth, which is unsuitable for bootstrapping. We extract and clean the bits of I in parallel. The bit extraction can be performed directly with polynomial interpolation. We also consider an alternative approach, inspired by the use of complex roots of unity in: we first evaluate a complex exponential I ∈ [symbol] [symbol] exp(2iπI/(2K+1)) ∈ [symbol] where K is an upper bound on |I|, and then extract the bits of I from exp(2iπI/(2K+1)) using the algorithm from. Once we have the bits, stored in a few ciphertexts, we can clean them as in, i.e., using the map h₁:x [symbol] 3x²−2x³ from. The cleaning is performed iteratively, until the target precision is obtained. The main advantage of our integer cleaning process is that most steps require only very small plaintext precision: indeed, bit extraction only aims to obtain bits. A cleaning iteration consumes two multiplicative levels and doubles the precision: overall, the modulus consumption of cleaning is essentially four times that of the output precision (two multiplicative levels in maximal precision, preceded by two multiplicative levels in half that precision, etc). Finally, we can recombine the cleaned bits

Let us now summarize our bootstrapping process for (a, b) ∈ [symbol] ² such that a·s+b=q₀·I+Δ·m.

Coefficients-to-slots. As the small integer polynomial I is in the coefficients, we use CtS to put it in slots. The plaintext precision depends only on the maximal bit-size of I, not on the precision of the message m.

Bit extraction. Using the fact that ∥I∥_{∞} is small, we bit-decompose it (coordinate-wise) and put its bits across several ciphertexts. The plaintext precision depends only on the maximal bit-size of I.

Iterative cleaning. We repeatedly apply the h1 map to clean each bit, to reach a precision that is a little above that of m. The total modulus consumption is approximately 4 times the precision of m.

Recombination. We recombine the bits into an integer that represents I. Assuming the bits are properly scaled, this is an addition.

Slots-to-coefficients. We put/back into coefficients using StC, resulting in an encryption of q₀·I in coefficients. The plaintext precision is a little more than that of m.

Subtraction. We subtract q₀·I from the original q₀·I+Δ·m, getting Δ·m as desired.

Optimizations. We now discuss several improvements of the bootstrapping procedure above.

First, we note that it is compatible with the skip connection technique from, which allows to obtain an StC-first bootstrapping variant. In StC-first bootstrapping, StC is run before ModRaise, at the lowest ciphertext modulus possible, rather than at the end of bootstrapping with a higher modulus. This amounts to swapping StC and non-bootstrapping computations. In most applications, non-bootstrapping computations are lighter than StC and it is beneficial to lower the modulus at which StC is performed. However, the skip connection technique involves an extra CtS branch in parallel of the low precision CtS, extraction and cleaning: it has to be performed in high precision, but its cost remains limited overall as a large amount of ciphertext modulus is available to accelerate it.

Second, we focus on iterative cleaning, as this is a significant contributor to run-time and modulus consumption, in the case of high-precision plaintexts. First, we describe a way to clean using trits rather than bits. For this purpose, we use the cleaning function from, which has degree 3 like the h₁ map. This reduces the number of digits and hence of ciphertexts to be cleaned in parallel. Second, concerning modulus consumption, as each cleaning iteration squares the scaling factor Δ, a direct approach consists in increasing Δ to the target scaling factor Δ² before applying h₁(x)=3x²−2x³ (or the trit-cleaning map). This results in a modulus consumption of Δ⁴, as there are two multiplicative levels. This direct approach wastes modulus because it views homomorphic multiplication as a black box. Instead, we use subcomponents of homomorphic multiplication to lower the modulus consumption. Homomorphic multiplication consists of tensoring, relinearization and rescaling. We view the underlying message at the beginning of cleaning as error-free, and observe that tensoring is error-free. Given a ciphertext ct encrypting a vector \vec{z} ∈ [symbol] ^{N/2} with a scaling factor Δ, we may compute ct′=Relin (ct⊗ct) which decrypts to \vec{z} ⊚\vec{z} with scaling factor Δ² (here the notation ⊚ refers to component-wise product). Note that achieving this already consumed 42 of modulus in the direct method, while our approach does not consume any modulus so far. Next, we compute the product between ct and ct′ whose tensor is also error-free. We save an extra factor Δ of modulus here. Finally, we rescale to lower the scaling factor from Δ³ to Δ. Overall, this results in a massive reduction of modulus consumption from Δ⁴ to Δ.

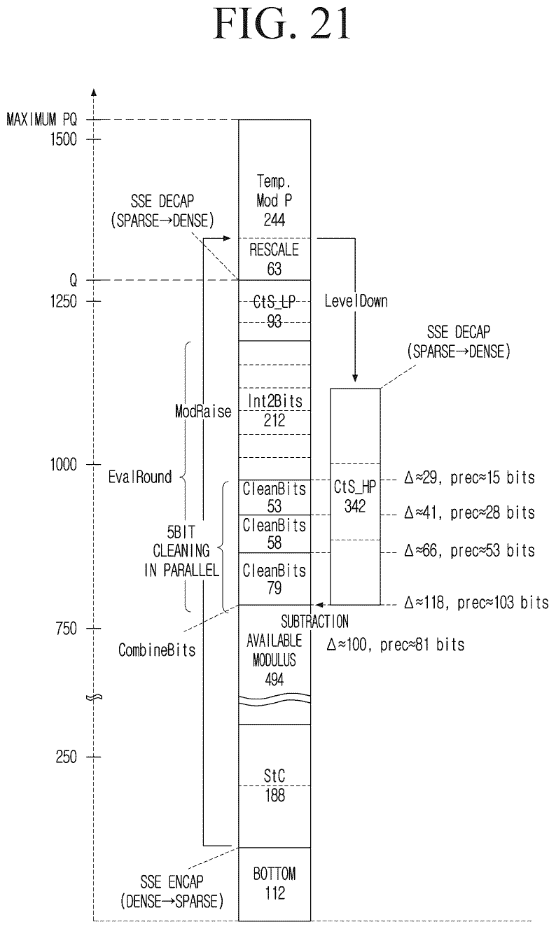

FIG. 21 gives an overview of our implementation design for bootstrapping with 81 bits of precision, in terms of modulus consumption of the different components.

FIG. 21: Overview of our bootstrapping implementation for 81-bit precision, parameter set Direct3Cln81. Modulus consumptions are given in each sub-procedure, in bits.

Applications. As explained earlier in this introduction, using high-precision for general computations with CKKS is necessary for the only approach known to achieve circuit privacy, IND-CPA-D security and secure threshold decryption: indeed, all known approaches require exponential noise flooding (as a function of the security parameter λ). It was even shown in that if one adds a Gaussian noise, then its standard deviation must grow exponentially with λ (this was later extended to circuit privacy in). Further, as these strong security properties are our main application focus, we set all our implementation parameters so that the bootstrapping failure probability is ε≤2⁻¹²⁸, using the formula from. Indeed, it was shown in that a larger ε may be exploited by the adversary.

Another application of high-precision CKKS bootstrapping was recently put forward in: bootstrapping BFV ciphertexts. This approach requires exceptionally high plaintext precision (hundreds of bits), which was handled using META-BTS with many iterations. If p refers to the BFV modulus and D the BFV multiplicative depth available after bootstrapping, then the CKKS plaintext precision is ≈ Dlogp. Our algorithm can be used as a drop-in replacement of META-BTS inside the BFV bootstrapping algorithm from.

Other related work. In a recent work, Li et al. proposed to replace the homomorphic evaluation of modular reduction used in conventional CKKS by homomorphic evaluation of the comparison function. The algorithm belongs to the “bootstrapping I family”. Given a ciphertext (a, b) ∈ [symbol] ² such that a·s+b=q₀·I+Δ·m, and assuming K is a known bound on ∥I∥_{∞}, their strategy consists in homomorphically comparing any given coefficient of I to −K, −K+1, . . . , K−1, K (using). These comparisons output bits (namely, 0 if smaller than the value, 1 else), so that the shifted sum of the bits is equal to I. Our design strategy applies to this bootstrapping algorithm. Indeed, up to the comparison, everything can be performed with small plaintext precision, and then the bits returned by the comparisons can be made more accurate by iterative cleaning, before being summed. However, we note that this involves 2K+1 parallel tracks for comparison and cleaning, as opposed to O(log K) in our case.

### Preliminaries

Let N>1 be a power-of-two integer and [symbol] = [symbol] [X]/(x^{N}+1). Given an integer q>1, we define R_{q}=R/qR. All our logarithms are in base 2. We let i be a square-root of −1 and, for x ∈ [symbol] , we let x denote the complex conjugate of x.

### CKKS Basics

The CKKS fully homomorphic encryption scheme relies on the Ring Learning With Errors (RLWE) problem for its security, and has a specific encoding structure of cleartexts into ring elements that enables SIMD computation over complex numbers. The discrete Fourier transform (DFT), from [symbol] [X]/(x^{N}+1) to [symbol] ^{N/2}, is defined as

$$D F T ( p ( X ) ) = {( p ( {ζ}^{{5}^{i}} ) )}_{0 \leq j < N / 2} ,$$

where ζ ∈ [symbol] is a primitive (2N)-th root of unity. The encoding map Ecd: [symbol] ^{N/2}→R is defined as

Ecd_{Δ}(\vec{z})=└Δ·iDFT(\vec{z})┐,

where iDFT is the inverse of DFT and Δ>0 is a scaling factor. As the DFT is a ring homomorphism respectively mapping addition and multiplication over [symbol] [X]/(x^{N}+1) to element-wise multiplication over [symbol] ^{N/2}, the encoding map allows to rely on arithmetic over R to enable approximate SIMD additions and multiplications over the complex plane. The scaling factor Δparametrizes the precision of those computations. In the context of CKKS, the coordinates of vectors in [symbol] ^{N/2} are called slots, as opposed to the coefficients of elements of R.

A coefficients-encoded CKKS ciphertext of m ∈ R is a pair of ring elements (a, b) ∈

$${ℛ}_{Q}^{2}$$

such that a·s+b≈Δ·m mod Q, where s is the secret key, Q is the current modulus and Δ is the current scaling factor. The three parameters s, Q and Δ may vary depending on the homomorphic computation context. Similarly, a slots-encoded CKKS ciphertext of \vec{z} ∈ [symbol] ^{N/2} is a pair (a, b) ∈

$${ℛ}_{Q}^{2}$$

such that α·s+b≈Δ·iDFT(\vec{z}) mod Q.

Native operations. The elementary homomorphic operations enabled by CKKS, defined over [symbol] ^{N/2}, include slot-wise addition, multiplication and (complex) conjugation, as well as cyclic rotations of coordinates by an arbitrary amount. Addition, conjugation, and rotations map ciphertexts modulo Q to ciphertexts modulo Q: they preserve the ciphertext modulus. Oppositely, multiplication maps ciphertexts modulo Q to ciphertexts modulo Q′≈Q/Δ≤Q: multiplication decreases modulus. Dividing the scaling factor and the ciphertext modulus of a ciphertext (a, b) ∈

$${ℛ}_{Q}^{2}$$

by ≈Δ is called rescaling and denoted RS_{Δ}((a, b)) ∈

$${ℛ}_{{Q}^{′}}^{2} .$$

Bootstrapping. For a fixed ring degree N, the ciphertext modulus Q is bounded from above because, otherwise, the underlying RLWE instances become insecure. Over the course of homomorphic computations, the ciphertext modulus may decrease, until reaching a bottom modulus q₀>1. The purpose of CKKS bootstrapping is to regain modulus. Conventional CKKS bootstrapping includes four components, namely ModRaise, CtS, EvalMod and StC.

ModRaise: The modulus raising step is computationally vacuous. It regards a ciphertext (decrypting to m ∈ [symbol] , i.e., with coefficients-encoding) at the bottom modulus q₀ as a ciphertext without modulus. Assuming that the input ciphertext is properly normalized (i.e., so that its coefficients belong to [−q₀/2, q₀/2)), the result of modulus raising is a ciphertext that decrypts to m+q₀·I for some I ∈ [symbol] whose coefficients have small absolute values.

CtS and StC: The coefficients-to-slots and slots-to-coefficients steps homomorphically evaluate iDFT and DFT, respectively. This allows to convert a coefficients-encoded ciphertext into a slots-encoded ciphertext (resp. vice versa). These steps are used because the output of ModRaise is better defined over coefficients, while the last bootstrapping component, EvalMod, involves SIMD computations over slots.

EvalMod: This fourth component homomorphically evaluates a modular reduction function, to remove the term I in m+q₀·I. A typical approach is to use a polynomial approximation of the modular reduction function, over a range that includes all possible values of the coefficients of I.

The components can be combined in two ways. CtS-first bootstrapping starts at the bottom modulus q₀, and can be described as StC∘EvalMod∘CtS∘ModRaise. StC-first bootstrapping starts at a slightly larger modulus to enable StC before reaching the bottom modulus q₀; it can be described as EvalMod∘CtS∘ModRaise∘StC. They differ in that CtS-first bootstrapping allows non-bootstrap computations at lower moduli than CtS-first bootstrapping, at the expense of performing StC at a higher ciphertext modulus: one may then be preferable over the other one depending on the relative costs of StC and the non-bootstrap computations.

Going further into details, we note that a ciphertext has N/2 complex-valued slots and N real-valued coefficients. As EvalMod requires real numbers in its slots, but/has N coefficients, EvalMod is preceded by a homomorphic extraction of real and imaginary parts (using complex conjugation), run twice in parallel, and followed by a recombination of the real and imaginary parts.

### Ciphertext Arithmetic

CKKS ciphertext operations involve operations in [symbol] _{Q} for often large moduli Q (e.g., of 1500 bits) and large ring degrees (e.g., N=2¹⁶). To obtain reasonable performance, one is led to set Q to be a product Q=q₁· . . . ·qₖ where the qⱼ's are prime and congruent to 1 modulo 2N. This modulus choice enables a double-CRT decomposition: first, elements in R_{Q} are represented as tuples in R_{q1}× . . . ×R_{qk}, via the Chinese Remainder Theorem; second, for each j≤k, elements of R_{qj} are handled as vectors in

$${ℤ}_{{q}_{j}}^{N}$$

via the Number Theoretic Transform (NTT), which can be viewed as another application of the Chinese Remainder Theorem.

In, which was subsequently adopted in most libraries implementing CKKS, the qⱼ's coincide with the rescaling involved in homomorphic multiplication. More concretely, as we saw earlier, homomorphic multiplication involves a modulus change from Q to a modulus Q′ satisfying Q′≈Q/Δ: one can then choose qⱼ≈Δ for all j and divide Q by one of its factors qⱼ to obtain Q′. This approach simplifies ciphertext arithmetic and creates significant parallelizability. On the downside, it ties the factorization of ciphertext moduli to the plaintext precision. If different plaintext precisions are required in a computation, then one can choose qⱼ's of different magnitudes corresponding to these precisions, and consistently “peal-off” the ciphertext modulus Q during homomorphic computations. This approach has at least three significant drawbacks: it becomes cumbersome when multiple precisions are required; very small plaintext precisions may not be achievable in this way, as there are not many small qⱼ's that are prime and congruent to 1 modulo 2N; efficiency is sub-optimal when the plaintext precision is not compatible with qᵢ's whose bit-lengths are just below 64 bits (or multiple thereof if using composite scaling).

Our bootstrapping algorithm relies on multiple precisions, making the ciphertext arithmetic from cumbersome and unnecessarily costly. Instead, we rely on the ciphertext arithmetic from rather than the one from. This work introduces a new technique, called grafting, that allows to decouple the arithmetic shape of the ciphertext moduli from the plaintext precision. It chooses most qⱼ's to have just below 64-bits, to decrease the number of qⱼ's for a total target bit-size for the ciphertext modulus Q. A single qⱼ is distinguished, to achieve a precise bit-length. Ciphertext multiplication only changes that qⱼ and possibly another one. As a result, the FHE implementer can arbitrarily choose plaintext precisions (or, equivalently, scaling factors 4), and they will be handled without loss of efficiency for ciphertext arithmetic. We note that a similar but somewhat less flexible approach was proposed in.

### Discrete CKKS

In, Drucker et al proposed to rely on the inclusion {0,1}^{N/2}⊂ [symbol] ^{N/2} to exploit the CKKS fully homomorphic encryption scheme for performing homomorphic binary computations. As all binary gates can be implemented as bivariate polynomials over [symbol] , SIMD binary gates can be implemented by relying on the native CKKS addition and multiplication. As CKKS computations are intrinsically noisy, the slots may be not so close to 0 or 1 after the evaluation of several binary gates. In order to keep the deviation from the distinguished points 0 and 1 bounded, Drucker et al introduced a framework called “cleaning”, which reduces such errors by evaluating well-designed polynomials. For instance, consider h₁(x)=3x²−2x³ (which had previously been considered in in the context of homomorphic comparisons): as h₁(0)=0, h₁(1)=1 and h_{1′}(0)=h_{1′}(1)=0, it preserves the underlying binary plaintext while essentially squaring the error. Elementary calculus provides the following result.

For all β E {0,1} and ε with |ε|≤1, we have:

|h₁(β+ε)−β|≤5|∃|².

We discuss an extension to trits in Appendix [app.trits].

### Proposed Bootstrapping

The conventional CKKS bootstrapping can be reformulated as a combination of embedding (i.e., ModRaise) and modular reduction (i.e., EvalMod). ModRaise raises the ciphertext modulus while adding a small multiple of q₀ denoted as q₀·I, whereas EvalMod homomorphically evaluates the modular reduction to remove it. The EvalRound algorithm takes a slightly different point of view. Instead of removing the q₀·I term directly, it reduces the associated noise and then subtracts the resulting ciphertext from the original one. At a high level, focusing on I obviates the need to maintain the plaintext message precision throughout bootstrapping. For instance, the main gain from was achieved by lowering the precision of CtS. We go a step further by redesigning EvalRound (instantiated as id—EvalMod in).

### Overview

We first recall the bootstrapping algorithm in (see Algorithm [alg:evalround]). EvalRound takes as input a low-precision ciphertext that contains an inaccurate integer vector \vec{I}+\vec{e} in its slots, with ∥\vec{I}∥_{∞}≤K for some integer K and ∥\vec{e}∥_{∞}≤ε for some ε ∈ (0,1/8), and outputs a high-precision ciphertext that contains the very accurate integer vector \vec{I}+\vec{e}′ in its slots, i.e. with ∥\vec{e}′∥_{∞}≤ε′ for some ε«ε. The bound ε′ is set so that subtraction from a ciphertext decrypting to q₀·\vec{I}+Δ·\vec{m} provides a ciphertext for m′ with the target plaintext precision. Recall (see the end of Subsection (sse: [basics]) that at this stage, bootstrapping operates on N/2 slots, but that there are N coefficients in the ring elements I created by ModRaise. This is handled by extracting the real and imaginary parts before running homomorphic rounding twice in parallel and then recombining: for the sake of notational simplicity, we consider that this is part of EvalRound. The notation CtS^{#} stresses that CtS is run in low plaintext precision. In contrast, StC is run with a precision that corresponds to ε′, so that the output ciphertext ctₒᵤₜ is sufficiently accurate.

$$ct ← ModRaise ( {ct}_{in} ) {ct}^{′} ← StC ∘ EvalRound ∘ {CtS}^{\#} ( ct ) {ct}_{out} ← ct - {ct}^{′}$$

Our proposed bootstrapping is identical to Algorithm [alg:evalround/, except that we give a different instantiation for EvalRound. For the new instantiation, we regard the ModRaise'd ciphertext ct=Enc (q₀·\vec{I}+Δ·m) as a discrete CKKS encryption of \vec{I} with scaling factor q₀·In discrete CKKS, removing è from q₀·\vec{I}+è corresponds to the cleaning functionality. To clean \vec{I}, we use the following “decompose, clean, and recombine” strategy:

Algorithm 1: Overview of the bootstrapping algorithm
in [KPK⁺ 22], our bootstrapping algorithm follows the same
high-level design.

```
  $Input : {ct}_{in} = Enc ( \vec{z} ) ∈ {ℛ}_{{q}_{0}}^{2} with \vec{z} ∈ {ℂ}^{N / 2} .$
  $Output : {ct}_{out} = Enc ( {\vec{z}}^{′} ) ∈ {ℛ}_{q}^{2} with {\vec{z}}^{′} \approx \vec{z} ∈ q >> {q}_{0} .$
1 ct ← ModRaise(ctᵢₙ);
2 ct′ ← StC ○ EvalRound ○ CtS^{#} (ct);
3 ctₒᵤₜ ← ct − ct′;
4 return ctₒᵤₜ.
```

DigitExtract. We decompose a noisy integer I=ΣⱼIⱼβ^{j}+e for some β into noisy smaller digits I₀+e₀, I₁+e₁, . . . ∈[0,β). By adding K, the integer/may be assumed to be non-negative.

VecClean. We clean the digits in parallel, i.e., for every j, we transform Iⱼ+eⱼ into Iⱼ+e_{j′} with a bound on |e_{j′}| that is much smaller than the bound on |eⱼ|.

Combine. We recombine the digits into an accurate version of I by computing Σⱼ(Iⱼ+e′ⱼ)·β^{j}.

The bootstrapping algorithm implements these steps homomorphically. We now formalize each step.

Let β>1,u>0 integers. Let ε ∈ (0,1/8] and ε_{de} ∈ (2ε, 1/Δ]. Let ct be a discrete-CKKS ciphertext decrypting to integer vector \vec{I}=(I₀,I₁, . . . , I_{N/2-1}) ∈ {0,1, . . . , β^{u}−1}^{N/2} slots-encoded via the inclusion [symbol] ⊂ [symbol] , and up to an error \vec{e} with ∥\vec{e}∥_{∞}≤ε. Digit extraction (DigitExtract) is a homomorphic operation that maps ct to (ct₀, ct₁, . . . , ctᵤ₋₁) such that, for all j and up to error \vec{e}^{(j)} with ∥\vec{e}^{(j)}∥_{∞}≤ε_{de}, the ciphertext ctⱼ decrypts to I(j)=(I₀ⱼ,I₁ⱼ, . . . , I_{(N/2-1)j}) ∈ {0,1, . . . , β−1}^{N/2} where

$${I}_{k} = \overline{{I}_{k ( u - 1 )} {I}_{k ( u - 2 )} … {I}_{k0}} ( β )$$

is the base-β representation of Iₖ, for all k. The Iₖⱼ's are slots-encoded and can be represented as integers or as complex roots of unity.

Vectorized cleaning simply refers to cleaning individual digits in parallel. The key advantage of digit extraction comes from the fact that cleaning smaller integer requires a smaller-degree cleaning polynomial and hence consumes less modulus.

Let β>1,u>0 integers and ε_{de}, ε_{clean} ∈ (0,1/Δ]. Let (ct₀, ct₁, . . . , ctᵤ₋₁) be a vector of ciphertexts such that, for all j and up to an error \vec{e}^{(j)} with ∥\vec{e}^{(j)}∥_{∞}≤ε_{de}, each ctⱼ decrypts to a vector in {0,1, . . . , β−1}^{N/2} with integer or roots-of-unity discrete-CKKS representations. Vectorized cleaning (VecClean) is a homomorphic operation that maps (ct₀, ct₁, . . . , ctᵤ₋₁) to (ct_{0′}, ct_{1′}, . . . , ct_{u-1′}) where, for all j and up to an error \vec{e}^{′(j)} with μ\vec{e}^{′(j)}∥_{∞}≤ε_{clean}, each ct′ⱼ decrypts to the same plaintext as ctⱼ under the same discrete-CKKS representation. (Each map ctⱼ [symbol] ct_{j′} is a valid discrete-CKKS cleaning.)

Recombination allows to recover the input integer vector \vec{I}, but a significantly more precise version thereof. Its complexity depends on the chosen base β and the choice of discrete CKKS representations.

Let β>1,u>0 integers and ε_{clean} ∈ (0,1/Δ]. Let (ct₀, ct₁, . . . , ctᵤ₋₁) be a vector of ciphertexts such that, for all j and up to error \vec{e}^{′(j)} with ∥\vec{e}^{′(j)}∥_{∞}≤ε_{clean}, each ctⱼ decrypts to a vector \vec{I}^{(j)}=(I₀ⱼ, I₁ⱼ, . . . I_{(N/2-1)j}) ∈ {0,1, . . . , β−1}^{N/2} with integer or roots-of-unity discrete-CKKS representations. Recombination (Combine) is a homomorphic operation that maps (ct₀, ct₁, . . . , ctᵤ₋₁) to ct′ that, up to an error \vec{e}′ with ∥\vec{e}′∥_{∞}≤2β^{u-1}. ε_{clean}, decrypts to \vec{I}=(I₀, I₁, . . . , I_{N/2-1}) ∈ {0,1, . . . , β^{u}−1}^{N/2} slots-encoded via the inclusion [symbol] ⊂ [symbol] , with Iₖ=Σ_{0≤j<u}β^{j}·Iₖⱼ for all k.

Our algorithm is identical to Algorithm [alg:evalround], with EvalRound instantiated as Combine. VecClean. DigitExtract.

Assume that ε′ and ε_{clean} satisfy 2β^{u-1}·ε_{clean}≤ε′. Given correct instantiations for digit extraction, vectorized cleaning and recombination, Algorithm [alg:evalround] with EvalRound instantiated as Combine∘VecClean∘DigitExtract is correct.

Proof. As provides a correctness analysis for Algorithm [alg:evalround], it suffices to check that the composition Combine∘VecClean∘DigitExtract is a correct instantiation of EvalRound, i.e., that it sends a ciphertext for a slots-encoded noisy vector \vec{I}+\vec{e} with \vec{I} ∈ [symbol] ^{N/2} and ∥\vec{e}∥∞≤ε, to a ciphertext for \vec{I}+\vec{e}′ with ∥\vec{e}′∥_{∞}≤ε′.

As the computation proceeds in a SIMD-manner (slots-wise), we focus on a single coordinate I+e of \vec{I}+\vec{e} to see what happens. Assuming that I belongs to [0, β^{u}), let I=I̅^̅{̅(̅u̅-̅1̅)̅}̅I̅^̅{̅(̅u̅-̅2̅)̅}̅ .̅ .̅ .̅ I̅⁽̅⁰̅⁾̅ (β) denote the base-β decomposition of I. The digit extraction function splits I+e into I⁽⁰⁾+e⁽⁰⁾, I⁽¹⁾+e⁽¹⁾, . . . , I^{(u-1)}+e^{(u-1)}, storing these in u different ciphertexts. The e^{(j)}'s may have increased compared to e but satisfy maxⱼ|e^{(j)}|≤ε_{de}. Next, the cleaning step cleans each digit I⁽⁰⁾, I⁽¹⁾, . . . , I^{(u-1)}, changing the e^{(j)}'s into e′^{(j)}'s satisfying maxⱼ|e′^{(j)}|≤ε_{clean}. Lastly, the recombination step allows us to obtain a ciphertext for I+e′, where |e′^{(j)}|≤2β^{u-1}. ε_{clean}≤ε′. This completes the proof.

Bootstrapping variants. Algorithm (alg:evalround/is of the CtS-first type, as it finishes with StC. It was modified into an StC-first variant in called EvalRound+bootstrapping. The input ciphertext ctᵢₙ is at a higher level. One applies a high-precision StC on it, before ModRaise. The ModRaise'd ciphertext decrypts to q₀·I+Δ·m (for coefficients encoding), for an integer I and the target plaintext m. This ciphertext then undergoes EvalRound∘CtS*, as in Algorithm [alg:evalround], to obtain a high plaintext-precision slots-encoded ciphertext decrypting to q₀·I. As the ModRaise'd ciphertext is coefficients-encoded, the authors from proposed to evaluate a high-precision CtS, in parallel of EvalRound∘CtS^{#}, and, finally, take the difference of the ciphertexts obtained in the two branches (hence removing the term q₀·I from q₀·I+Δ·m, in slots). EvalRound+bootstrapping is oblivious to how EvalRound is instantiated, and hence it can be used with EvalRound instantiated as Combine∘VecClean∘DigitExtract. One drawback is that it involves two runs of CtS, one in small plaintext precision and one in high plaintext precision. However, the second one has ample modulus to be performed (all the modulus consumed by EvalRound∘CtS^{#}), providing room to optimize its cost. On the plus side, EvalRound+bootstrapping enjoys a faster StC as 1) it is performed with smaller ciphertext modulus (it is StC-first) and 2) its plaintext precision needs to be sufficient to store Δ·m as opposed to q₀. I+Δ·m.

Our algorithm can be optimized in the case of thin bootstrapping, i.e., when the plaintext has only n meaningful slots instead of N/2. Using a subring of R at bottom level, of degree N′ ∈[2n, N], it is known that StC and CtS can be accelerated (see, e.g.,). As a side-effect of using a subring, in Algorithm [alg:evalround] and its EvalRound+variant, the number of integers I to be cleaned is only N′≤N. In our case, this can be exploited to accelerate vectorized cleaning. Indeed, in this case, we can pack the digits of coefficients of I into [uN′/(N/2)] ciphertexts. Packing and unpacking can be achieved using homomorphic rotations.

### Extraction, Cleaning and Recombination

We now give approaches for implementing DigitExtract, VecClean and Combine.

Digit extraction. The most direct approach to obtain the digit Iⱼ of I consists in evaluating a Lagrange interpolation. If |Iⱼ| is known to be bounded by some integer K=β^{u}−1, then Iⱼ can take only 2K+1 values. The Lagrange polynomial has degree≤2K, which may be implemented multiplicative depth log (2K+1). This provides a solution with low multiplicative depth, but it is typically numerically unstable when K is not very small, as the derivative of the interpolating polynomial on the distinguished points can be very high. To compensate, this forces us to instantiate CtS^{#} with a higher precision. To ensure a better numerical stability, one may consider a function that is constant in small intervals around the possible inputs and approximate it for the L_{∞} norm on those intervals. Such a polynomial can be obtained through the improved multi-interval Remez algorithm from. The approximation becomes more precise when the degree increases and/or the intervals become thinner.

We now describe another approach. It starts from the observation that there exists an efficient procedure to extract bits from integers encoded as complex roots-of-unity. We note that it generalizes to base β digits for β≥2. It takes as inputs that are close approximations to roots-of-unity of a power-of-β order {exp(2iπI/β^{κ}): 0≤I<β^{κ}}. As in the general case, obtaining the bits of I can be viewed as a Lagrange interpolation, but it turns out that the interpolating polynomials are sparse and can be evaluated efficiently (e.g., in base 2, the least significant bit is extracted using x [symbol] (1−x²−1)/2). As the input to DigitExtract is a ciphertext whose plaintext is an integer vector that is slots-encoded via the inclusion Z ⊂ C, to use this algorithm, we first need to transform it into a ciphertext for the same integer vector but with roots-of-unity representation. For this purpose, we first evaluate x [symbol] exp(2inx/β^{κ}). We approximate the complex exponential by a polynomial Pₑₓₚ=P_{cos}+iPₛᵢₙ, where P_{cos} and Pₛᵢₙ are polynomials that respectively approximate scaled versions of cos and sin. As we are interested in only a few input points and we tolerate relatively large output inaccuracy (as extraction is followed by cleaning anyways), it turns out in practice that a degree-8 polynomial suffices.

The most time-consuming homomorphic operations during polynomial evaluation are ciphertext-ciphertext, or non-scalar, multiplications. Note that direct approach requires the evaluation of K different polynomials on the same input. It can be achieved with 2\sqrt{κd} non-scalar multiplications, where d≥β^{κ} denotes the degree of the polynomials, using the Paterson-Stockmeyer algorithm. In contrast, the digit extraction polynomials from complex roots-of-unity can be seen as polynomials of degree β^{κ}, β^{κ-1}, . . . , β in x, x^{β}, . . . x^{β-1}, respectively. As the degrees follow a geometric series, this results in O(\sqrt{β^{κ}}) non-scalar multiplications for that approach. The multiplicative depth may be a little higher than the direct approach, but the running time is lower.

Digit cleaning. Cleaning bits was introduced in: as recalled in Lemma (le:bit clean], applying the h₁ map essentially doubles the precision of the bit under scope. It can be evaluated within two multiplicative levels. One option for VecClean is to iterate the evaluation of the h₁ map several times, doubling the accuracy every time, until matching the target accuracy. Since we have low precision at the beginning, it suffices to use a very small scaling factor Δ. Then, between two iterations, the scaling factor Δ can be squared, so that the homomorphic noise does not pollute the accuracy gain from h₁. Another option for cleaning bits would be to use a higher degree polynomial which still sends x ∈ {0,1} to x but has several successive derivatives that vanish in both 0 and 1. This may decrease the total number of multiplicative levels allowing to reach a desired accuracy, but it has two drawbacks: first, evaluating higher degree polynomials is more costly; second, it seems that the final scaling factor is required for all multiplicative levels, in contrast with the iterative method that uses such a scaling factor only at the last iteration. The latter cancels the multiplicative depth advantage.

In Appendix (app:trits], we extend vectorized cleaning to trits.

### Modulus Consumption

We now discuss the modulus consumption of the bootstrapping algorithm. This directly impacts throughput, as the total amount of available modulus is bounded (else the Ring-LWE parametrization becomes insecure) and we are interested in maximizing the number of homomorphic multiplications between consecutive bootstraps.

The ring degree N impacts the modulus consumption, as every multiplicative level comes with a homomorphic computation noise whose bit-length is O(log N). This contributes to a total of O(log N) modulus consumption. Now, let us consider the modulus consumption dependency in the target plaintext precision t (i.e., the precision of the input and output of bootstrapping).

The precision before cleaning can be bounded independently of t, as cleaning allows to reach any precision, from inputs that are barely precise enough so that the underlying plaintexts are well-defined. The overall modulus consumption all all these steps is hence O(1) (assuming that N is constant). Let t₀ be the plaintext precision right before cleaning.

Assume that we use the same cleaning function at every iteration and that it improves the precision by a factor a>1 in b multiplicative levels. The first iteration is performed at plaintext precision t₀·a as it aims to multiply precision by a factor a. It hence consumes t₀·a·b bits of modulus. The modulus consumption of subsequent iterations follows a geometric progression; the total modulus consumption is then

$${t}_{0} \cdot a \cdot b + {t}_{0} \cdot {a}^{2} \cdot b + … + t \cdot b \approx t \cdot \frac{ab}{a - 1} = O ( t ) .$$

If using d levels of DFT recursion (typically, we have d≤3), then the modulus consumption of StC is ≈d·t.

Note that only the end of cleaning and StC have multiplicative levels with large scaling factors.

Comparison with prior approaches. The direct approach is to take the classical CKKS bootstrapping and increase the precision of every multiplicative level linearly with t. further, this algorithm relies on a polynomial approximation to a trigonometric function, whose degree must grow as O(t) so that it is accurate enough. This leads to a multiplicative depth growing as O(log t) and a modulus consumption that grows as O(tlogt). The running time also grows faster than that of our algorithm, due to the increased number of multiplicative levels.

Finally, we discuss the Meta-BTS algorithm from, which consists in running a precision t₀ bootstrapping t/t₀ times. Assuming that t₀ is a constant, this gives O(t) iterations. The modulus consumption still grows linearly in O(t), as this is the precision of the input and output. (The constant is lower than ours, though.)

### Low Modulus-Consumption Cleaning

Although starting from small precision and iteratively cleaning the digits reduces modulus consumption greatly, the precision-increasing cleaning steps may consume significant modulus. In this section, we propose techniques to further reduce the modulus consumption, saving a factor Δcompared with the direct approach.

### Low Modulus Consumption for Bits

We first consider the degree-2 cleaning polynomial h₁:x= [symbol] 3x²−2x³ for bits {0,1}. We are given as input a ciphertext ct ∈

$${ℛ}_{Q}^{2}$$

for some ciphertext modulus Q decrypting to a vector \vec{z}=\vec{b}+\vec{e} of noisy bits (in slots), with \vec{b}={0,1}^{N/2} and ∥\vec{e}∥_{∞}≤2^{-t} for some t≥0. The scaling factor Δ is a little more than 2^{t}, so that the homomorphic computation error is not larger than the bound on \vec{e}. The purpose of h₁ is to obtain a ciphertext ctₒᵤₜ ∈

$${ℛ}_{{Q}_{o u t}}^{2}$$

for \vec{z}ₒᵤₜ=\vec{b}+\vec{e}ₒᵤₜ, for the same \vec{b} but with ∥\vec{e}∥_{∞}≤2^{-2t+c} for some small constant c (see Lemma (le:bit clean). The scaling factor of the output ciphertext ctₒᵤₜ hence needs to be of the order of Δ². Our goal is to reduce the modulus consumption, i.e., the ratio Q/Qₒᵤₜ

$$\begin{matrix}1 : {ct}_{1} = Δ \cdot ct ∈ {ℛ}_{Q}^{2} : \\ 2 : {ct}_{2} = {Mult}_{{Δ}^{2}} ( {ct}_{1} , {ct}_{1} ) ∈ {ℛ}_{Q / {Δ}^{2}}^{2} ; \\ 3 : {ct}_{3} = {Mult}_{{Δ}^{2}} ( {ct}_{1} , {ct}_{3} ) ∈ {ℛ}_{Q / {Δ}^{4}}^{2} ; \\ 4 : {ct}_{last} = 3 \cdot {ct}_{3} - 2 \cdot {ct}_{3} ∈ {ℛ}_{Q / {Δ}^{2}}^{2} .\end{matrix}$$

$$\begin{matrix}1 : {ct}_{1} = Δ \cdot ct ∈ {ℛ}_{QΔ}^{2} : \\ 2 : {ct}_{2} = {Mult}_{{Δ}^{2}} ( {ct}_{1} , {ct}_{1} ) ∈ {ℛ}_{Q / Δ}^{2} ; \\ 3 : {ct}_{3} = {Mult}_{{Δ}^{2}} ( {ct}_{1} , {ct}_{2} ) ∈ {ℛ}_{Q / {Δ}^{3}}^{2} : \\ 4 : {ct}_{out} = 3 \cdot {ct}_{2} - 2 \cdot {ct}_{3} ∈ {ℛ}_{Q / {Δ}^{4}}^{2} .\end{matrix}$$

$$\begin{matrix}1 : {ct}_{1} = ct \text{?} ct ∈ {ℛ}_{Q}^{3} : \\ 2 : {ct}_{2} = Relin ( {ct}_{1} ) ∈ {ℛ}_{Q}^{2} : \\ 3 : {ct}_{3} = Relin ( ct \text{?} {ct}_{2} ) ∈ {ℛ}_{Q}^{2} . \\ 4 : {ct}_{4} = 3 \cdot Δ \cdot {ct}_{2} - 2 \cdot {ct}_{3} ∈ {ℛ}_{Q}^{2} : \\ 5 : {ct}_{out} = {Rescale}_{Δ} ( {ct}_{4} ) ∈ {ℛ}_{Q / Δ}^{2} .\end{matrix}$$

$$\text{?} \text{indicates text missing or illegible when filed}$$

Table 1.2: The black-box approach (left), the inverse rescaling approach (middle) and the thrifty approach (right) for evaluating h₁.

The black-box approach. We start with a direct approach that relies on homomorphic addition and multiplication as black-boxes. Given ct ∈

$${ℛ}_{Q}^{2} ,$$

the direct evaluation of h₁ would proceed as table 1.2 (left side). At Step 1, multiplying the ciphertext by Δ has the effect of increasing the scaling factor to Δ², while keeping a plaintext that is ≈\vec{z}. At Steps 2 and 3, the homomorphic multiplications are with scaling factor Δ², leading to a loss of a factor Δ² in ciphertext modulus (twice). Note that Q/Δ² and Q/Δ⁴ may not be integers. We abuse notations to refer to integers that are close to the values. Finally, the multiplications by 3 and 2 of Step 4 are plaintext-ciphertext multiplications with an exact and small plaintext, for which no rescaling is required. Overall, the modulus consumption of this black-box approach is 44.

Inverse rescaling approach. As a first non-black-box optimization, we observe that multiplying by Δ in Step 1 of the black-box approach actually gives us a ciphertext ct1 with modulus QΔ. Up to adjusting the ciphertext moduli accordingly, the rest of the algorithm stays the same. This observation reduces modulus consumption from Δ⁴ to Δ³. See table 1.2 (center).

The thrifty approach. We improve the modulus consumption even further, by a detail inspection and optimization of the components of homomorphic multiplication. Homomorphic multiplication Mult_{Δ} for a scaling factor Δ proceeds in three steps:

Tensor: given ct=(a, b) and ct′=(a′, b′) in

$${ℛ}_{Q}^{2} ,$$

tensor outputs ct ⊗ ct′=(aa′,ab′+a′b,bb′) ∈

$${ℛ}_{Q}^{3} ;$$

if ct and ct′ respectively decrypt to \vec{z} and \vec{z}′under the key (s,1) and with scaling factor Δ, then the output decrypts to \vec{z} ⊚ \vec{z}′ with scaling factor Δ² under (s², s, 1) where ⊚ refers to the component-wise product over [symbol] ^{N/2}.

Relinearization: given ct ∈

$${ℛ}_{Q}^{3} ,$$

Relin outputs ct′ ∈

$${ℛ}_{Q}^{2}$$

with the same plaintext (up to a homomorphic evaluation error) and the same scaling factor.

Rescaling: given ct ∈

$${ℛ}_{Q}^{2} ,$$

Rescale outputs ct′ ∈

$${ℛ}_{Q / Δ}^{2}$$

with the same plaintext (up to a homomorphic evaluation error) and a scaling factor divided by Δ.

In the thrifty approach, we first view the input ciphertext ct=(a, b) ∈

$${ℛ}_{Q}^{2}$$

as an error-free ciphertext decrypting to \vec{z} ∈ [symbol] ^{N/2}, i.e., satisfying:

$$DFT ∘ Dec ( ct ) = Δ \cdot \vec{z} ,$$

where Dec consists in taking the inner product with (s, 1). As the discrete Fourier transform DFT between [symbol] [X]/(x^{N}+1) and [symbol] ^{N/2} is a homomorphism, the tensor operation does not introduce any error:

$$DFT ∘ {Dec}^{′} ( ct ⊗ ct ) = {Δ}^{2} \cdot \vec{z} ⊙ \vec{z} ,$$

where Dec′ refers to the inner product with (s², s, 1). Based on this observation, we evaluate h₁ as described in the right-hand side of table 1.2. The modulus consumption is reduced from Δ⁴ or Δ³, down to Δ.

The thrifty approach for h₁, given in Table 1.2, is correct.

Proof. To prove correctness, we examine the errors underlying the ciphertexts occurring during the computation. Recall that relinearization and rescaling introduce homomorphic evaluation errors, which are bounded independently of the scaling factor. The input satisfies DFT∘Dec (ct)=Δ·\vec{z} ∈ [symbol] ^{N/2}. As we have seen, the ciphertext ct₁ satisfies DFT∘Dec′(ct₁)=Δ²·\vec{z} ⊚ \vec{z}. We may write

$$DFT ∘ Dec ( {ct}_{2} ) = {Δ}^{2} \cdot \vec{z} ⊙ \vec{z} + {\vec{e}}_{Relin} ,$$

for some relinearization error e_{Relin} At Step 3, we first apply tensor and relinearization. We have

$$DFT ∘ Dec ( Relin ( {ct}_{3} ) ) = ( Δ \cdot \vec{z} ) ⊙ ( {Δ}^{2} \cdot \vec{z} ⊙ \vec{z} + {\vec{e}}_{Relin} ) + {\vec{e}}_{Relin}^{′} ,$$

for some other relinearization error \vec{e}′_{Relin}. Therefore, at Step 4, we have:

$$DFT ∘ Dec ( Relin ( {ct}_{4} ) ) = {Δ}^{3} \cdot {h}_{1} ( \vec{z} ) + {\vec{e}}_{4} ,$$

where h₁ is applied componentwise and ∥\vec{e}₄∥_{∞} is at most of the order of Δ. After rescaling by Δ, we obtain

$$DFT ∘ D e c ( c {t}_{out} ) = {Δ}^{2} \cdot {h}_{1} ( \vec{z} ) + {\vec{e}}_{out} ,$$

where ∥eₒᵤₜ∥_{∞} is O(1) (as a function of Δ). Lemma [le:bit clean/then allows us to conclude.

We now consider the modulus consumption resulting from k cleaning iterations implemented with the thrifty approach.

Assume we apply the thrifty approach as described in table 1.2 k times, to increase the scaling factor from Δ to Δ², to Δ⁴, etc up to Δ^{sk}. The overall modulus consumption is Δ^{2k-1}.

Proof. We observe that at the j th iteration, the scaling factor increases from Δ^{2j-1} to Δ^{2j}, resulting in a modulus consumption of Δ^{2j-1}. Then the total modulus consumption is

$${Π}_{1 \leq j \leq k} {Δ}^{{2}^{j - 1}} = {Δ}^{{Σ}_{1 \leq j \leq k} {2}^{j - 1}} = {Δ}^{{2}^{k} - 1} .$$

Asymptotically, we double the precision at every cleaning step, and the scaling factor should grow from Δ to Δ². However, in practice, there is a gap of c bits between logΔ and the plaintext precision t, due to homomorphic evalution errors (e.g., c≈12). When applying cleaning, we double logΔ, but this gap is also doubled from c to 2c, even though the homomorphic evaluation errors still have only around c bits: the resulting ciphertext has scaling factor Δ² and precision 2t. To handle this, we reduce the scaling factor, using a rescaling operation, so that the gap is reduced from 2c to c, because otherwise the scaling factor would grow faster than the precision and would result in unnecessary modulus consumption in the subsequent cleaning steps. Therefore, we rescale the output ciphertext by Δ/2^{t}, consuming Δ2/2^{t} bits in total.

A further difficulty comes from the fact that we need to scale z² (in ct₂) by Δ at Step 4, so that the scaling factor matches with that of z³ (in ct₃). This implicitly assumes that Δ is an integer. If this is not the case, then it is tempting to encode Δ as a plaintext, but this creates a homomorphic evaluation error that is too large for the correctness proof to work. Instead, if Δ is not an integer, we replace it by a close-by integer Δ′ at the outset. Consider Δ′=[Δ] ∈ [symbol] . Then we may write

$$DFT ∘ Dec ( ct ) = Δ \cdot \vec{z} = {Δ}^{′} \cdot {\vec{z}}^{′}$$

$$for {\vec{z}}^{′} = ( Δ / {Δ}^{′} ) \vec{z} ∈ {ℂ}^{N / 2} . Here we observe that$$

$${‖ {\vec{z}}^{′} - \vec{z} ‖}_{∞} = {‖ ( \frac{{Δ}^{′} - Δ}{Δ} ) \vec{z} ‖}_{∞} \leq \frac{{‖ \vec{z} ‖}_{∞}}{Δ} .$$

Hence, we may view \vec{z}′ as a new representation of the initial vector \vec{z}, with an integer scaling factor Δ′.

### Extensions

The thrifty approach can be extended to cleaning trits, as detailed in Appendix [app:trits].

The approach can be further generalized. Let ct ∈

$${ℛ}_{Q}^{2}$$

be a ciphertext decrypting to \vec{z} ∈ [symbol] ^{N/2}, with scaling factor Δ. Based on the fact that the tensor operation is error-free, we may perform an error-free high degree (integer-coefficient) polynomial evaluation. Assume we want to evaluate x [symbol] Σ_{0≤j≤k}αⱼx^{j} with integer coefficients αⱼ. We can proceed as follows.

For 2≤j≤k, compute ctⱼ=Δ^{k-j}·Relin(ct^{⊗j}) ∈

$${ℛ}_{Q}^{2} ,$$

where the notation ct^{⊗j} means that we tensor j copies of ct; this decrypts to Δ^{k}·\vec{z}^{j}+\vec{e}ᵣₑₗᵢₙ with ∥\vec{e}ᵣₑₗᵢₙ∥≤O(Δ^{k-j}).

Compute and return ctₒᵤₜ=α₀+α₁·ct+Σ_{2≤j≤k}αⱼctⱼ.

The scaling factor of ctₒᵤₜ is Δ^{k} As the terms α₀ and α₁·ct are exact, the largest relinearization error is O(Δ^{k-j0}), where j₀=min{j≥2: αⱼ≠0}. In the case of h₁, we have k=3 and j₀=2, leading to a Δ² gap between “plaintext” and error.

### Experiments

Our code is developed upon the C++ HEaaN library, using the grafting technique from. All our experiments were performed using a single thread on an Apple M4 Pro equipped with 32GiB of RAM, running macOS Sequoia 15.2. All our experiments were repeated at least 20 times. Reported execution times are averaged over experiments. Precision is defined as the negative base-2 logarithm of the maximum error shown when decrypted, observed across all experiments.

### Arithmetic Aspects

Grafting. Our implementation uses the grafting technique proposed in. It removes the dependencies between the ciphertext modulus and the scaling factors that exist in RNS-CKKS. During iterative cleanings, we start with a ciphertext with small precision and increase the precision by cleaning with the increased scaling factors. Grafting avoids situations where a large number of small-size NTT primes are required but there are not enough of them. In grafting, two ciphertext moduli are usually not divisible by one another, so the rescaling operations are performed using modulus switching. When rescaling from a ciphertext modulus Qa ∈ [symbol] to another ciphertext modulus Qb ∈ [symbol] , we refer the situation to rescaling by [log₂(a/b)] bits where a/b≈2^{[log2 (a/b)]}, which is usually the case. Also, the scaling factors are not directly tied to the modulus and are changing during the operations; therefore, they should be accurately tracked along the computation.

High-Precision Arithmetic. The scaling factors must be large enough to achieve high-precision bootstrapping, as the inherent encoding and decoding errors are roughly inversely proportional to the scaling factors. Also, we must handle scaling factors with large precision while tracking them throughout homomorphic computations and using them for encoding and decoding. To this end, we use libquadmath, the GCC library for quadruple precision arithmetic. Note that the CKKS ciphertexts do not need high-precision real numbers as they are represented exactly using integers.

### Implementation Details

All of our parameters satisfy 128-bit security for the Ring-LWE instances they rely upon, according to the lattice estimator. In addition, we also target more advanced security notions like IND-CPA-D and circuit privacy, as well as secure Threshold-FHE, and thus require bootstrapping to succeed with a probability that is exponentially close to 1. Our parameter sets extract 5 bits from the integer approximating the rounding function for the erroneous integer I+(Δ/q₀)m for a 32-period piecewise input domain, a union of small intervals centered at each integer I ∈ [−16,15]. Using a Hamming weight h=30 for the ternary secret key, we have a zero failure probability for this approximation, thanks to ∥I+(Δ/q₀)m∥_{∞} . . . =∥(b+as)/q₀∥_{∞}≤(h+1)/2=15.5, where (a, b) ∈ [symbol] _{q}_{₀} is the ciphertext before ModRaise.

We implement both extractions, the direct approximation of integers to bits, and the indirect approximation through roots of unity.

In the indirect case, as explained in Section [sec:ExplainImpl], we first use an approximation of the complex exponential function, to map erroneous integers I ∈ [−2^{κ-1}, 2^{κ-1}−1] to erroneous roots of unities exp(2iπI/2^{κ}). For this purpose, we use a degree-8 dense polynomial, where the inputs are scaled into [−π, π]. Note that the degree-8 polynomial can be computed in log 28=3 multiplicative levels instead of [log 28+1]=4, thanks to grafting: we evaluate the polynomial made of the first 8 monomials using the scaled coefficients, add x⁸, and then reset the scaling factor by dividing it by the highest-degree coefficient. From the roots of unity, we obtain bits by relying on the bit extraction technique of Bae et al.

Other choices are possible for the complex exponential polynomial, such as with degrees 4 and 16, which can be evaluated in multiplicative depths of 2 and 4, respectively. The polynomials of degrees 4, 8 and 16 give approximation precisions of 3.3, 12 and 36.5 bits, respectively. We choose degree 8, as it is accurate enough to compute the complex exponential of the integer I while preserving its precision. Note that the initial accuracy of I (compared to [I]) is roughly an inverse of the gap q₀/Δ since we have I+(Δ/q₀)m in the coefficients after ModRaise.

In the case of direct extraction, we implement 5 different degree-47 polynomials, one for each bit. This degree allows us to extract bits and preserves precision. Degree-47 is a good compromise between ease of evaluation and small approximation error. The evaluation of these five polynomials requires only 22 non-scalar multiplications since we can precompute the odd polynomial basis up to degree 15 (8 terms) and the Chebyshev polynomials T₂, T₄, T₈, T₁₆, T₃₂ (5 terms), and reuse them very efficiently: evaluating an odd polynomial p(X) of degree 47 only requires 2 non-scalar multiplication by expressing it as p(X)=P₀(X)+T₁₆·p₁(X)+T₃₂·p₂(X), while using multiplicative depth of 6. We remark that the indirect digit extraction via roots of unity also requires a similar cost of 21 key-switchings, but using two more multiplicative depths: 6 non-scalar multiplications for mapping the integers to roots of unity, 10 non-scalar multiplications, and 5 conjugations for extracting digits from roots of unity.

For cleaning the extracted bits, we use h₁(x)=3x²−2x³. The cleaning polynomial is evaluated iteratively using the optimization techniques explained in Section [sec:The Trick]. As the precision doubles with each iteration, a larger initial precision requires fewer cleaning iterations. However, the initial precision is limited by the scaling factors of the homomorphic DFTs, i.e., StC and CtS, and digit extraction. Increasing them would noticeably increase the modulus consumption.

Selecting Scale Factors and Modulus Gap. We can achieve a given target bootstrapping precision by appropriately choosing the scale factors for each sub-operation and the bottom modulus. As mentioned above, the gap g=q₀/Δ for the StC scale factor Δ plays a crucial role by setting the initial precision of the erroneous integer, along with the scale factors for StC and CtS. When the erroneous bits are extracted, their precision cannot exceed the gap. In practice, the Most Significant Bit (MSB) loses around 4 bits of precision. During each cleaning iteration, the precision is roughly doubled. When the bits are combined and subtracted with the high-precision CtS result, we get the messages divided by the gap. Thus, the precision of the message, when scaled correctly, is (log∂)-bit smaller than that of the combined integer. More precisely, let us assume we have high-precision CtS result Ĩ:=I+(Δ/q₀)m+ε₀ and the EvalRound result [Ĩ]+ε₁ for small errors ε₀, ε₁ of magnitude 2^{-p}. The subtraction gives (Δ/q₀)m+ε₀−ε₁, where the magnitude of the relative error becomes≈2^{-(p-log∂)}. The resulting bootstrapping precision becomes≤(2^{nb_cln}·(log∂−4)−log∂) bits, where nb_cln is the number of iterations for cleanings.

Note that the scale factors can be chosen based on the precisions required for each step, heuristically considering the inherent error term in the ciphertext for each operation. When decrypted and decoded, the RLWE error is multiplied by the secret key and the decoding matrix, introducing a O(\sqrt{Nh}) error to the message, where h is the secret key Hamming weight and N is the ring degree. Due to this inherent noise, the scaling factor should be at least δ≈log\sqrt{Nh} bits larger than the message precision; hence, the smallest possible scaling factor Δ for a given plaintext precision t would satisfy logΔ≥t+δ. Especially during iterative cleanings, the scale factors Δ≈2^{t+δ} and precision t, respectively, change into Δ′≈Δ³/(Δ·2^{δ})≈2^{2t+δ}and t′=2t, consuming (t+2δ) bits of modulus.

StC-First Versus CtS-First. The EvalRound bootstrapping algorithm (see Algorithm [alg:evalround]) starts with CtS, whereas the EvalRound+algorithm allows to start with StC. We opt for the latter as it allows to decrease modulus consumption in StC, for a moderate increase in execution time.

Our FGb Variant. To compare with our bootstrapping, we choose one of the standard and well-optimized FHE parameter sets with ring degree N=2¹⁶, namely the FGb of. It is similar to a parameter set in the Lattigo library. We consider a modification of FGb so that it incorporates grafting. For fair comparison, we made the following modifications: using secret key encapsulation to decrease the degree of the EvalMod polynomial and to decrease the bootstrapping failure probability; using only two multiplicative levels for StC instead of three to lower modulus consumption while not affecting the execution time too much; using a larger dnum of 6 instead of 5, maximizing the throughput among the possible choices. We refer to this modified FGb parameter set as FGb*.

### Experimental Results and Comparison

| Parameter | | | | | BTS modulus | | | | | Throughput |
|---|---|---|---|---|---|---|---|---|---|---|
| Sets | Cleaning | | | | consumption | | | Available | Time | (modulus/ |
| (N = 2 [symbol] ) | iterations | Prec. | Budget | Bottom | StC | ER/EM | CtS [symbol] (CtS) | modulus | [symbol] | time) |
| Indirect2Cln37 | 2 | 37 | 1289 | 44 | 62 | 321 | 132 | 670 | 12.6 | 53.09 |
| Direct2Cln39 | 2 | 39 | 1289 | 46 | 66 | 300 | 135 | 742 | 14.3 | 51.78 |
| Indirect3Cln37 | 3 | 37 | 1289 | 70 | 114 | 473 | 84 (210) | 632 | 18.4 | 34.29 |
| Direct2Cln38 | 2 | 38 | 1289 | 79 | 118 | 349 | 105 (300) | 640 | 17.9 | 35.75 |
| Indirect4Cln80 | 4 | 80 | 1289 | 110 | 194 | 457 | 84 (354) | 443 | 20.7 | 21.42 |
| Direct3Cln81 | 3 | 81 | 1289 | 112 | 188 | 402 | 93 (354) | 494 | 20.9 | 23.66 |
| FGb [symbol] | — | 23 | 1289 | 58 | 58 | 464 | 159 | 550 | 8.5 | 64.63 |
| FGb [symbol] -Meta- | — | [symbol] 40 | 1289 | 78 | 58 | 464 | 159 | 530 | 17.0 | 31.14 |
| BTS | | | | | | | | | | |
| FGb [symbol] -Meta- | — | [symbol] 80 | 1289 | 118 | 58 | 464 | 153 | 490 | 34.0 | 14.39 |
| BTS | | | | | | | | | | |
| EvalRound+ | — | 16 | 1298 | 58 | 86 | 522 | 93 | 546 | — | — |

[symbol]

indicates data missing or illegible when filed

Table 2: Modulus consumptions and execution times for various CKKS bootstrapping algorithms. Note that the throughput should be compared between the parameter sets with similar bootstrapping precision.

In Table [tab:mod_time], we introduce our parameters, their modulus consumption, and timings with different numbers of cleaning iterations. The ring dimension is N=2¹⁶, and the maximum modulus PQ is set to 1533 bits. We propose parameter sets for precisions near 20, 40 and 80, based on direct extraction (Direct) and extraction via roots of unity (Indirect). The number of cleanings is given in the parameter names, followed by the precision of the bootstrapping.

For EvalRound+, the figures are not based on our code but borrowed from. As the timings from are unfairly uncompetitive due to a different code-base, we did not report them in Table [tab:mod_time]. We expect that using sparse secret encapsulation, the EvalRound+will also have a very small failure probability (for a small modulus consumption increase).

For any ring degree (here N=2¹⁶), there is a maximum modulus budget that can be used for RLWE samples to achieve 128-bit security. When the rank of the gadget decomposition for the switching keys is set, the maximum ciphertext modulus is determined, which is shown as the budget in Table [tab:mod_time]. EvalRound+has a larger budget than the other parameter sets, possibly thanks to a larger gadget rank dnum. We chose dnum=6, the same as FGb*'s.

Throughput Comparison. To compare the bootstrapping algorithms, we consider throughput. Here, it is defined as the remaining available modulus for multiplication after bootstrapping divided by the bootstrapping time. The direct parameter set Direct3Cln81 with 3 cleanings provides a throughput of 494/20.88≈23.66 bits/s. We compare it with Meta-BTS applied to the FGb* parameter set. By iterating the FGb* bootstrapping four times, consuming an extra 80−20=60 bits of modulus for storing the plaintext to be bootstrapped, we can obtain ≈80 bits of precision by repeating the FGb* bootstrapping four times sequentially. This provides roughly an 80-bit precision CKKS bootstrapping that runs in approximately 8.51·4=34.04 seconds. In terms of throughput, this gives 14.39 bits/s, which is 1.64× smaller than with our parameter set Direct3Cln81.

Profiling Sub-procedures. We provide the detailed behavior of the sub-procedures of our bootstrapping in Figures [fig:BAR_GRAPH] and 1, the modulus consumption and the run-time, respectively. Figure [fig:BAR_GRAPH] gives the detailed modulus consumption during bootstrapping. The purple block on the left of each tall bar is for the high-precision CtS with 122-bit scaling factors. The black dotted line illustrates skip connection. The thin little blocks are for rescalings and cleanings.

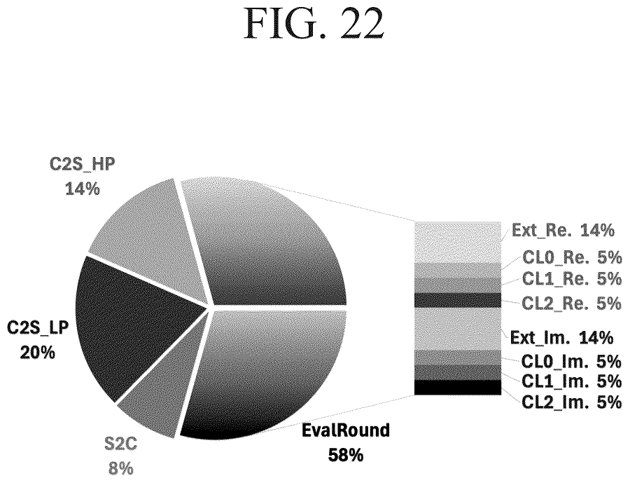

FIG. 22: Profiled run-time of Parameter Set Direct3Cln81.

As cleaning is done in multiple parallel tracks, it consumes a significant part of the total execution time. The two CtS's with both lower and high precision are next, in terms of run-time share. We observe that the high-precision CtS is faster than the low-precision CtS: this is because the high-precision CtS is run at a smaller modulus. The 2-level StC is about 10% of the total execution time, which is of a similar portion compared to usual CKKS bootstrapping. Those proportions do not change with other parameter sets.

### Using Trits Rather Than Bits

Cleaning trits. An extension of cleaning from bits to integers was considered in by using the inclusion of bounded integers in the set of real numbers, and relying on binary decomposition for cleaning. Chung et al proposed to rather rely on complex roots of unity to encode bounded integers: an integer k ∈ [0, t−1] is represented as exp(2iπk/t) ∈ C. Binary gates are extended by using polynomial interpolation over such roots of unity, whereas cleaning is performed using the function ∂ₜ:x= [symbol] ((t+1) x-x^{t+1})/t. It may be checked that ∂ₜ evaluates the identity function on the exp(2iπk/t)'s and that these values are roots of ∂ₜ′. These properties ensure that ∂ₜ increases the accuracy of the distinguished roots of unity. An alternative roots-of-unity cleaning function ft was proposed in: x,y= [symbol] (y^{t-1}+2 (t−1) x−(t−1) x²y)/t and evaluated in (x, y)=(x, x̅). Evaluating it requires homomorphic conjugation, but consumes less multiplicative depth when t or t+1 is a power of 2.

For all β ∈ {exp(−2iπ/3),1, exp(2 iπ/3)} and ε, ε′ with |ε|, |ε′]≤1, we have:

$$\vert {f}_{3} ( β + ε , \overline{β} + {ε}^{′} ) - β \vert \leq 3 {max ( \vert ε \vert , \vert {ε}^{′} \vert )}^{2} .$$

We note that the bound does not require ε′ to be ε̅.

Proof. Consider x, y ∈ [symbol] . We have:

$$\begin{matrix}3 \cdot {f}_{3} ( x + ε , y + {ε}^{′} ) = {( y + {ε}^{′} )}^{2} + 4 ( x + ε ) - 2 {( x + ε )}^{2} ( y + {ε}^{′} ) \\ = 3 \cdot {f}_{3} ( x , y ) + 4 ε ( 1 - xy ) + 2 {ε}^{′} ( y - {x}^{2} ) - 2 {ε}^{2} y - 4 {εε}^{′} x + {ε}^{′2} - 2 {ε}^{2} {ε}^{′} .\end{matrix}$$

Now, for x=β and y=β̅, we observe that ƒ₃(x, y)=3x, 1−xy=y−x²=0. The result then follows from the triangle inequality.

Digit cleaning with trits. In Section [sec:ExplainImpl], we explained how to perform digit cleaning with binary decomposition. Using a higher base β reduces the number of ciphertexts to be handled in parallel during vectorized cleaning, by a factor log₂β. However, increasing β may induce extra multiplicative depth. Note that representing integers as complex roots of unity has been suggested to be preferable over representing integers via the inclusion Z ⊂ C (see). Table 2 compares costs of different cleaning functions for β-th roots of unity for various positive integers β. Interestingly, third roots of unity can encode log₂3≈1.58 bits of information and can be cleaned for the same cost as for bits. (This advantage decreases when it comes to thrifty cleaning, as explained below.)

| | | | | | mult. |
|---|---|---|---|---|---|
| β | log₂ (β) | cleaning function | mult. | conj. | depth |
| 2 | 1.00 | $\frac{3}{2} x - \frac{{x}^{3}}{2}$ | 2 | 0 | 2 |
| 3 | 1.58 | $\frac{4}{3} x - \frac{{x}^{4}}{3}$ | 2 | 0 | 2 |
| 3 | 1.58 | $\frac{1}{3} {\overline{x}}^{2} + \frac{4}{3} x - \frac{2}{3} {x}^{2} \overline{x}$ | 2 | 2 | 2 |
| 4 | 2.00 | $\frac{5}{4} x - \frac{{x}^{5}}{3}$ | 3 | 0 | 3 |
| 4 | 2.00 | $\frac{1}{4} {\overline{x}}^{3} + \frac{3}{2} x - \frac{3}{4} {x}^{2} \overline{x}$ | 3 | 2 | 2 |

Table 3: Efficiency comparison of cleaning functions for different bases β.

Reconstruction. Reconstructing bits into an integer is direct, using a power-of-two linear combination. Combining third roots of unity into the corresponding integer does not required multiplication as we can extract the imaginary part with conjugation: this maps exp(−2iπ/3), 1 and exp(2 iπ/3) to −½, 0 and ½, respectively, from which reconstructing becomes direct. For β=4, we could not find a reconstruction algorithm that would not require a multiplicative level. Note that at this stage, we are at maximal scaling factor, so a multiplicative level consumes a large amount of modulus.

Extractions. For the integer-to-roots conversion, we can use the same exponential polynomial of approximation range of [−π, π], by scaling the messages in the input range I ∈ [−(β^{κ}/2−1), β^{κ}/2−1], resulting in erroneous roots of unities exp(2iπI/β^{κ}), where β=3.

For the roots-to-trits conversion, we extend the approach of Bae et al. to trits. For any k, we consider the Lagrange interpolation polynomials

$${P}_{3 , ℓ}^{( k )} ' s$$

from exp(2iπ Σ_{0≤j≤k} 3^{j}Iⱼ) to Iₗ for all 0≤l<k. They turn out to be sparse. For concreteness, we give their shape below for k=3 (i.e., for I's that can take 3³=27 values).

$${P}_{3 , 0} = {x}^{9} ,$$

$${P}_{3 , 1} = {α}_{3} {x}^{3} + {α}_{12} {x}^{12} + {α}_{21} {x}^{21} ,$$

$${P}_{3 , 2} = {α}_{2} {x}^{2} + {α}_{5} {x}^{5} + {α}_{3} {x}^{3} + {α}_{11} {x}^{11} + {α}_{14} {x}^{14} + {α}_{17} {x}^{17} + {α}_{20} {x}^{20} + {α}_{23 {x}^{23} + {α}_{26} {x}^{26}} .$$

for some αᵢ's in [symbol] .

Cleanings. For cleaning the extracted trits, we use

$${f}_{3} ( x , y ) = \frac{1}{3} {y}^{2} + \frac{4}{3} x - \frac{2}{3} {x}^{2} y ( in ( x , y ) = ( x , \overline{x} )$$

We have seen in Section [sec:The Trick] a thrifty approach for cleaning bits. We now extend it to trits.

We “hide” the constant multiplication by ⅓ of ƒ₃ in the rescaling, so that we only compute the integer polynomial y²+4x−2x²y. We then proceed as described in table 1.2, starting from a ciphertext ct ∈

$${ℛ}_{Q}^{2}$$

decrypting to a (noisy binary) vector \vec{z} with scaling factor Δ.

1: c̅t̅ := conj(ct);
$2 : {\overline{ct}}_{1} := \overline{ct} ⊗ \overline{ct} ∈ {ℛ}_{Q}^{3} ;$
$3 : {\overline{ct}}_{2} := Relin ( {\overline{ct}}_{1} ) ∈ {ℛ}_{Q}^{2} ;$
$4 : {ct}_{3} := Relin ( ct ⊗ {\overline{ct}}_{2} ) ∈ {ℛ}_{Q}^{2} ;$
$5 : {\overline{ct}}_{3} := conj ( {ct}_{3} ) ∈ {ℛ}_{Q}^{2} ;$
$6 : {ct}_{4} := Δ \cdot {\overline{ct}}_{2} + 4 \cdot {Δ}^{2} \cdot ct - 2 \cdot {\overline{ct}}_{3} ∈ {ℛ}_{Q}^{2} ;$
$7 : {ct}_{out} := {Rescale}_{Δ} ( {ct}_{4} ) ∈ {ℛ}_{Q / Δ}^{2} .$

Table 3.2: The thrifty approach for evaluating ƒ3.

Theorem A.2. The thrifty approach for ƒ₃, given in table 1.2, is correct.

Proof. We first recall that the function ƒ(x)=(\tilde{x}²+4x−2x²\tilde{x})/3 can clean the errors of \tilde{x} and x at the same time: the error for \tilde{x} does not need to be the complex conjugate of the error for x (see Lemma [le:trit_clean]). Even if x and \tilde{x} have independent errors, the function ƒ doubles the accuracy of x ∈ {exp(−2iπ/3), 1, exp(2 iπ/3)}.

Now, assume that the input ct decrypts to \vec{z}. The ciphertext c̅t̅ computed at Step 1 decrypts to \vec{w} with scaling factor Δ, i.e., it satisfies DFT∘Dec (c̅t̅)=Δ·\vec{w}. Using the observation above, we view \vec{w} as an error-free variable that is close to \vec{z}. Now:

$$DFT ∘ Dec ( {\overline{ct}}_{2} ) = {Δ}^{2} \cdot \vec{w} ⊙ \vec{w} + {\vec{e}}_{Relin} ,$$

for some small relinearization error \vec{e}_{Relin}. Then, the computation of ct₃ and c̅t̅₃ give

$$DFT ∘ Dec ( {ct}_{3} ) = ( Δ \vec{z} ) ⊙ ( {Δ}^{2} \cdot \vec{w} ⊙ \vec{w} + {\vec{e}}_{Relin} ) + {\vec{e}}_{Relin}^{′} ,$$

$$DFT ∘ Dec ( {\overline{ct}}_{3} ) = ( Δ \overline{\vec{z}} ) ⊙ ( {Δ}^{2} \cdot \overline{\vec{w}} ⊙ \overline{\vec{w}} + {\overline{\vec{e}}}_{R e l i n} ) + {\overline{\vec{e}}}_{R e l i n} + {\vec{e}}_{conj} ,$$

for other small errors \vec{e}′_{Relin} and \vec{e}_{conj}. We observe that the term of interest is scaled by Δ³ and that the error terms are at most scaled by Δ. This is also the case for the summands Δ·c̅t̅₂ and Δ²·ct at Step 6. Lemma [le:trit_clean] allows us to complete the proof.

Parameter sets. We provide an alternative parameter set using trit-based extractions, extracting from 27 periods, i.e., a range [−13,13]. It has 2⁻⁴⁹ failure probability, which is not suitable for circuit privacy and IND-CPA-D security, nor for threshold-FHE.

| | #periods | | | |
|---|---|---|---|---|
| Params. | (K) | Fail. Prob. | Extract. Method | Cleaning |
| Alternative | 3³ (13) | 2⁻⁴⁹ | Int2Roots2Trits | h₁ on 3 trits |

Table 4: Parameter sets for CKKS bootstrapping in high precision using trits.

Meanwhile, methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade for a conventional electronic apparatus.

In addition, the aforementioned various embodiments of the disclosure may also be performed through an embedded server provided on an electronic apparatus, or an external server of at least one of an electronic apparatus or a display device.

Also, according to an embodiment of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include the electronic apparatus according to the embodiments disclosed herein. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not distinguish whether data is stored in the storage medium semi-permanently or temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store. In the case of on-line distribution, at least a portion of a computer program product may be stored in a storage medium such as the server of the manufacturer, the server of the application store, and the memory of the relay server at least temporarily, or may be generated temporarily.

Also, each of the components (e.g.: a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

In addition, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. An electronic apparatus comprising:
at least one processor including processing circuitry; and
memory,
wherein the at least one processor is configured to:
obtain a scale factor and an input ciphertext of a first modulus,
obtain a modified scale factor by extending the scale factor to a second modulus,
obtain a modified input ciphertext by extending the input ciphertext to the second modulus,
obtain a first sub ciphertext by multiplying the modified scale factor and the modified input ciphertext,
obtain a second sub ciphertext of a third modulus based on the first sub ciphertext,
obtain a third sub ciphertext of a fourth modulus based on the first sub ciphertext and the second sub ciphertext, and
obtain a converted ciphertext based on the second sub ciphertext and the third sub ciphertext.

2. The electronic apparatus of claim 1,
wherein the converted ciphertext is a ciphertext wherein noises decreased in the input ciphertext.

3. The electronic apparatus of claim 2,
wherein the at least one processor is configured to:
decompose each coefficient of an integer polynomial included in the input ciphertext into a unit bit in a form of a binary number, and
obtain the converted ciphertext wherein the noises in the unit bit decreased.

4. The electronic apparatus of claim 1,
wherein the at least one processor is configured to:
obtain the second sub ciphertext by performing a homomorphic multiplication operation (mult) of the first sub ciphertext and the first sub ciphertext.

5. The electronic apparatus of claim 4,
wherein the at least one processor is configured to:
obtain a first value by performing a polynomial multiplication (tensor) for the first sub ciphertext and the first sub ciphertext,
obtain a second value by performing a relinearization operation for the first value, and
obtain the second sub ciphertext by performing a rescale operation in a rescale unit for the second value.

6. The electronic apparatus of claim 5,
wherein the at least one processor is configured to:
obtain the third sub ciphertext by performing a homomorphic multiplication operation (mult) of the first sub ciphertext and the second sub ciphertext.

7. The electronic apparatus of claim 6,
wherein the at least one processor is configured to:
obtain a first modified ciphertext by modifying the second modulus of the first sub ciphertext to the third modulus, and
obtain the third sub ciphertext by performing a homomorphic multiplication operation (mult) of the first modified ciphertext and the second sub ciphertext.

8. The electronic apparatus of claim 7,
wherein the at least one processor is configured to:
obtain a fourth value by performing a polynomial multiplication (tensor) for the first modified ciphertext and the second sub ciphertext,
obtain a fifth value by performing a relinearization operation for the fourth value, and
obtain the third sub ciphertext by performing a rescale operation in the rescale unit for the fifth value.

9. The electronic apparatus of claim 8,
wherein the at least one processor is configured to:
obtain the converted ciphertext by applying the second sub ciphertext and the third sub ciphertext to a predetermined purified polynomial.

10. The electronic apparatus of claim 9,
wherein the at least one processor is configured to:
obtain a second modified ciphertext by modifying the third modulus of the second sub ciphertext to the fourth modulus, and
obtain the converted ciphertext by applying the second modified ciphertext and the third sub ciphertext to the predetermined purified polynomial.

11. A method of controlling an electronic apparatus, the method comprising:
obtaining a scale factor and an input ciphertext of a first modulus;
obtaining a modified scale factor by extending the scale factor to a second modulus;
obtaining a modified input ciphertext by extending the input ciphertext to the second modulus;
obtaining a first sub ciphertext by multiplying the modified scale factor by the modified input ciphertext;
obtaining a second sub ciphertext of a third modulus based on the first sub ciphertext;
obtaining a third sub ciphertext of a fourth modulus based on the first sub ciphertext and the second sub ciphertext; and
obtaining a converted ciphertext based on the second sub ciphertext and the third sub ciphertext.

12. The controlling method of claim 11,
wherein the converted ciphertext is a ciphertext wherein noises decreased in the input ciphertext.

13. The controlling method of claim 12,
wherein the controlling method comprises:
decomposing each coefficient of an integer polynomial included in the input ciphertext into a unit bit in a form of a binary number, and
the obtaining the converted ciphertext comprises:
obtaining the converted ciphertext wherein the noises in the unit bit decreased.

14. The controlling method of claim 11,
wherein the obtaining the second sub ciphertext comprises:
obtaining the second sub ciphertext by performing a homomorphic multiplication operation (mult) of the first sub ciphertext and the first sub ciphertext.

15. The controlling method of claim 14,
wherein the obtaining the second sub ciphertext comprises:
obtaining a first value by performing a polynomial multiplication (tensor) for the first sub ciphertext and the first sub ciphertext;
obtaining a second value by performing a relinearization operation for the first value; and
obtaining the second sub ciphertext by performing a rescale operation in a rescale unit for the second value.

16. The controlling method of claim 15,
wherein the obtaining the third sub ciphertext comprises:
obtaining the third sub ciphertext by performing a homomorphic multiplication operation (mult) of the first sub ciphertext and the second sub ciphertext.

17. The controlling method of claim 16,
wherein the obtaining the third sub ciphertext comprises:
obtaining a first modified ciphertext by modifying the second modulus of the first sub ciphertext to the third modulus; and
obtaining the third sub ciphertext by performing a homomorphic multiplication operation (mult) of the first modified ciphertext and the second sub ciphertext.

18. The controlling method of claim 17,
wherein the obtaining the third sub ciphertext comprises:
obtaining a fourth value by performing a polynomial multiplication (tensor) for the first modified ciphertext and the second sub ciphertext;
obtaining a fifth value by performing a relinearization operation for the fourth value; and
obtaining the third sub ciphertext by performing a rescale operation in the rescale unit for the fifth value.

19. The controlling method of claim 18,
wherein the obtaining the converted ciphertext comprises:
obtaining the converted ciphertext by applying the second sub ciphertext and the third sub ciphertext to a predetermined purified polynomial.

20. The controlling method of claim 19,
wherein the obtaining the converted ciphertext comprises:
obtaining a second modified ciphertext by modifying the third modulus of the second sub ciphertext to the fourth modulus; and
obtaining the converted ciphertext by applying the second modified ciphertext and the third sub ciphertext to the predetermined purified polynomial.
